(19) United States
(12) Patent Application Publication
(10) Pub. No.: US 2018/0276962 A1
(43) Pub. Date: Sep. 27, 2018

(54) MONITORING AND AUTOMATION SYSTEMS, AND RELATED METHODS

(71) Applicant: INTAMAC SYSTEMS LIMITED, Northampton (GB)

(72) Inventors: Robert BUTLER, Northampton (GB); Daniel CULLEY, Northampton (GB); Kevin DUFFY, Northampton (GB); Mark FARRINGTON, Northampton (GB); Steve HOUGH, Northampton (GB); Mark LEE, Northampton (GB); John MCEWAN, Northampton (GB); Ajith SURENDRAN, Northampton (GB)

(21) Appl. No.: 15/571,245

(22) PCT Filed: May 3, 2016
(86) PCT No.: PCT/GB2016/051270

§ 371 Date: Nov. 1, 2017

(30) Foreign Application Priority Data
May 1, 2015 (GB) 1507594.8

(51) Int. Cl. G08B 13/196; G06F 9/54; G06F 17/30; H04L 29/08; H04N 5/232; H04L 12/24

(52) U.S. Cl. CPC G08B 13/19682; G06F 9/547; G06F 9/542; G06F 17/30312; H04L 67/10; H04L 12/2803; H04L 41/22; G08B 13/19656; G08B 13/19669; G08B 13/1968; H04L 67/26; H04N 5/23206

(57) ABSTRACT

A system comprising an agent system and a cloud platform, the agent system including a device handler and a communications manager, the cloud platform including components including: a receiver module; a platform management layer including a rules engine; a database; application programming interfaces (APIs), and a user interface.

### BACKGROUND OF THE INVENTION

### 1. Field of the Invention

The field of the invention relates to monitoring and automation systems, and to methods of operating or using such systems.

### 2. Technical Background

Video cameras have for many years been used for surveillance in areas that necessitate monitoring, notably banks, shops, airports, convenience stores and other public places. Video cameras are now also increasingly being used as part of home and business security systems in order to give home owners and business owners peace of mind.

Many camera manufacturers produce Internet Protocol (IP) compatible cameras, which allow a certain degree of remote access via an asymmetric digital subscriber line (ADSL), cable or broadband internet connections. However, most cameras of this type have, until now, had many practical limitations which have limited their usage. One such limitation is that these IP compatible cameras are generally configured to communicate only one way with any ease. That is to say, most IP cameras are operable to transmit images to a certain electronic device, but it is complex for a user to remotely view images in certain circumstances, or to control attributes or configuration settings of the cameras.

Network arrangements of security devices (e.g. video cameras) are too complex for even reasonably computer literate users to deal with in an acceptable amount of time. Without the appropriate knowledge and skill-set, configuring network arrangements can be very difficult and the installation and alteration of systems of this type is usually left to an experienced service engineer. In addition, if anything goes wrong with these systems, most end users do not have the requisite knowledge to rectify problems. This makes networked arrangements of security devices (e.g. security cameras) systems of this type difficult to operate, unreliable and/or expensive to install and maintain.

### 3. Discussion of Related Art

WO2009138721 (A2) discloses a camera network management apparatus which is configured to enable a user to issue control instructions to at least one camera and view an image stream from the camera. The user and camera are in different locations both remote from the camera network management apparatus. The camera network management apparatus comprises a device manager arranged to receive a camera instruction from a user and provide said instruction to the camera responsive to a polling message from the camera. It also comprises a streaming device capable of requesting an image stream from the camera and supplying the image stream to a user device.

However, numerous difficulties remain in setting up and using device network management apparatus e.g. in security applications. It is desirable to be able to add or remove devices easily from a network. It is desirable to be able to alter the functionality or behavior easily of a device already present on the network. It is desirable to make a device on the network respond automatically to a triggering event, such as a very specific event, without human intervention. It is desirable for the network management apparatus to respond automatically to a triggering event, without human intervention. It is desirable to allow a user to be guided quickly through recorded security data to the most relevant data. It is desirable to be able to control devices in a device network easily, whether the user is local to or remote from a particular device.

GB2377313(A) and GB2377313(B) disclose an alarm system, eg for detecting intruders in the home, including a sensor and a camera for generating data suitable for production of a picture to be sent to a remote internet server in response to the sensor detecting an event. The system may also include a recorder and means to store images. GB2377313(A) and GB2377313(B) further disclose a security system communication network comprising an internet server; a first receiving unit for receiving a first type of data and for placing said first type of data in a format suitable for interpretation by the internet server; a second receiving unit for receiving a second type of data and for placing said second type of data in a format suitable for interpretation by the internet server; and a security system remote from the internet server and receiving units, the security system comprising a camera as a source of the first type of data; a first means for sending the first type of data to the first receiving unit; a source of the second type of data; and a second means for sending the second type of data to the second receiving unit.

EP2770714(A1) and EP2770714(B1) disclose a cloud agent realizing method, including that: an agent is communicatively connected to a cloud agent server, acquires a parameter of the agent and a parameter of the cloud agent server from the cloud agent server, and logs in to the cloud agent server according to the acquired parameters. Also disclosed are a cloud agent realizing system and a cloud agent server. With the disclosure, cloud agent registration and management are realized in a Call Center Cloud.

### SUMMARY OF THE INVENTION

According to a first aspect of the invention, there is provided a system comprising an agent system and a cloud platform,

the agent system including a device handler and a communications manager,

the cloud platform including components including: a receiver module; a platform management layer including a rules engine; a database; application programming interfaces (APIs), and a user interface,

wherein the agent system is configured to communicate with the receiver module via the communications manager, using a data model, the device handler configured to communicate with a plurality of devices each including respective firmware, the device handler configured to communicate with the communications manager,

wherein the receiver module is configured to receive event data generated by the respective firmware on the plurality of devices, and to pass event data to the database to be stored, wherein stored event data in the database is accessible to the platform management layer, the platform management layer configured to process the event data according to the rules engine to generate output actions, commands or messaging,

wherein the APIs are connectable via the user interface to at least one other cloud platform component, which is operable via the APIs to push a command or new firmware to a connected device in the plurality of devices.

An advantage is that connected devices may be commanded, or have their firmware updated, from the cloud platform, which increases the ease with which systems comprising an agent system and a cloud platform, in which the agent system communicates with a plurality of connected devices, can use or modify the firmware, of the plurality of connected devices.

The system may be one in which the device handler is provided as an embedded software module.

The system may be one in which the device handler is configured to communicate with the plurality of devices using radio frequency (RF) communications.

The system may be one in which the device handler is configured to abstract command messages from the cloud platform so as to be radio technology agnostic.

The system may be one in which the communications manager uses Extensible Markup Language (XML) as the data-description language used to pass data and commands to and from the cloud platform.

The system may be one in which the communications manager uses a combination of XML and JavaScript Object Notation (JSON) to describe data and encapsulate it in the data model.

The system may be one in which data are exchanged between the agent system and the cloud platform using the Extensible Messaging and Presence Protocol (XMPP).

The system may be one in which data are exchanged between the agent system and the cloud platform using the MQTT (formerly Message Queue Telemetry Transport) protocol.

The system may be one in which the data model provides a sophisticated abstraction making it possible to bring data together into a common form regardless of the underlying source or protocols which are used to communicate between devices.

The system may be one in which passed data and commands between the agent system and the cloud platform are secured using encryption.

The system may be one in which the communications manager handles a device being connected or disconnected in the background.

The system may be one in which the receiver module receives the data via the defined data model for each device and processes the data according to assigned protocols.

The system may be one in which the database is a SQL server.

The system may be one in which the database is one which stores all account, devices and configuration data as new data which can be added, changed and deleted frequently.

The system may be one in which the database is a time series database design which stores the event, telemetry and diagnostic information that can be reported by the devices/sensors connected to the cloud platform.

The system may be one in which the time series database is used to support data analytics on services such as energy consumption, diagnostics.

The system may be one in which the APIs are representational state transfer (REST) APIs.

The system may be one in which the API's provide data access to core cloud platform functionality.

The system may be one in which the data access is authenticated and encrypted so that only authorised partners can gain access.

The system may be one in which the API's are usable to connect user interfaces to the cloud platform.

The system may be one in which third party developers are provided with a software development kit (SDK) so that business partners can develop and deploy user interfaces independently.

The system may be one in which the user interface supports connected home services.

The system may be one in which the home services include one or more of security, video, automation, heating, lighting, rules, and social care.

The system may be one in which event and diagnostic information is displayable via the user interface.

The system may be one in which the user interface supports one or more of web, mobile (IOS, Android and Windows), Smart TV, tablets, and set top boxes (STB) platforms.

The system may be one in which the new firmware includes non-intrinsic firmware.

The system may be one in which the non-intrinsic firmware is embedded software or scripts which may be run alongside the intrinsic firmware.

The system may be one in which the new firmware includes intrinsic firmware.

The system may be one in which the firmware includes camera firmware.

The system may be one in which the agent system includes a device manager.

The system may be one in which the device manager converts data received via RF protocols from wireless devices to a generic format.

The system may be one in which the device manager converts commands received from the cloud platform to a structure understood by the device manager.

The system may be one in which the agent system includes a rules engine.

The system may be one in which the rules engine controls system logic for connected home services.

The system may be one in which the rules engine allows the agent system to make decisions based on data that is received from sensors registered to the agent system without the need to communicate with the cloud platform.

The system may be one in which the rules engine allows the agent system to operate autonomously if connection to the cloud platform is lost.

The system may be one in which the rules engine can receive new rules from the cloud platform via scripts.

The system may be one in which the agent system includes a Telemetry Rules Engine.

The system may be one in which the Telemetry Rules Engine monitors the flow of regularly reported telemetry data values such as energy, power, temperature, voltage, flow-rate, speed, rpm and acceleration.

The system may be one in which the Telemetry Rules Engine includes bounds checks which generate events if the bounds are exceeded.

The system may be one in which the agent system includes a camera.

The system may be one in which the cloud platform triggers an alarm on an alarm generating device when motion is detected on the camera.

The system may be one in which the alarm is a siren.

The system may be one in which the alarm generating device is a hub.

The system may be one in which the agent system includes a Video Communications Manager.

The system may be one in which the Video Communications Manager provides a persistent connection using XMPP to the cloud platform.

The system may be one in which the Video Communications Manager provides a persistent connection using MQTT to the cloud platform.

The system may be one in which the Video Communications Manager uses a combination of STUN (Session Traversal Utilities for NAT (Network address translation)) and XMPP to provide a communications mechanism to negate NAT traversal and remove the need for an end user to enable port forwarding for the device.

The system may be one in which the Video Communications Manager uses a combination of STUN (Session Traversal Utilities for NAT (Network address translation)) and MQTT to provide a communications mechanism to negate NAT traversal and remove the need for an end user to enable port forwarding for the device. The system may be one in which the agent system includes audio analysis functions.

The system may be one in which the agent system audio analysis functions include a rule that if a specific sound is detected then the agent system generates an event that is sent to the cloud platform to be processed.

The system may be one in which the agent system audio analysis functions include use of sound packs, wherein the sound packs are respectively enabled or disabled upon receipt of a respective command from the cloud platform.

The system may be one in which the agent system includes a Video Stream Transmission function.

The system may be one in which the Video Stream Transmission function includes receiving a video stream from a camera, and sending the stream to the cloud platform.

The system may be one in which the video stream is a Real-time Transport Protocol (RTP) video stream.

The system may be one in which the video stream is encrypted prior to sending the stream to the cloud platform.

The system may be one in which the Video Stream Transmission function includes use of security certificates.

The system may be one in which the cloud platform includes a platform communications layer.

The system may be one in which the cloud platform includes video processing.

The system may be one in which the video processing includes receiving encrypted H.264 video via Secure Real-time Transport Protocol (SKIP) and then processing the received video so that it can be supported on multiple platforms.

The system may be one in which the video processing includes providing cloud video recording and clip storage.

The system may be one in which the cloud platform includes a video receiver.

The system may be one in which the video receiver includes the functions of receiving a video stream and then performing decryption and then passing the decrypted video stream to a video proxy server to be transcoded and streamed to a requesting device.

The system may be one in which the cloud platform includes operations support system/business support system (OSS/BSS) integration.

The system may be one in which the cloud platform includes an administration system.

The system may be one in which the administration system provides account, device and diagnostic information.

The system may be one in which the cloud platform includes a messaging engine.

According to a second aspect of the invention, there is provided a computer implemented method of operating a system comprising an agent system and a cloud platform,

the agent system including a device handler and a communications manager,

the cloud platform including components including: a receiver module; a platform management layer including a rules engine; a database; application programming interfaces (APIs), and a user interface, the method including the steps of:

(i) the agent system communicating with the receiver module via the communications manager, using a data model,

(ii) the device handler communicating with a plurality of devices each including respective firmware,

(iii) the device handler communicating with the communications manager,

(iv) the receiver module receiving event data generated by the respective firmware on the plurality of devices, and passing event data to the database to be stored,

(v) the platform management layer accessing stored event data in the database,

(vi) the platform management layer processing the stored event data according to the rules engine to generate output actions, commands or messaging,

(vii) the APIs connecting via the user interface to at least one other cloud platform component, and

(viii) the at least one other cloud platform component being operated by the APIs to push a command or new firmware to a connected device in the plurality of devices.

An advantage is that connected devices may be commanded, or have their firmware updated, from the cloud platform, which increases the ease with which systems comprising an agent system and a cloud platform, in which the agent system communicates with a plurality of connected devices, can use or modify the firmware, of the plurality of connected devices.

The method may be one including the step of the device handler communicating with the plurality of devices using radio frequency (RF) communications.

The method may be one including the step of the device handler abstracting command messages from the cloud platform so as to be radio technology agnostic.

The method may be one including the step of the communications manager using Extensible Markup Language (XML) as the data-description language used to pass data and commands to and from the cloud platform.

The method may be one including the step of the communications manager using a combination of XML and JavaScript Object Notation (JSON) to describe data and encapsulate it in the data model.

The method may be one including the step of the exchanging the described data between the agent system and the cloud platform using Extensible Messaging and Presence Protocol (XMPP).

The method may be one including the step of the exchanging the described data between the agent system and the cloud platform using MQTT.

The method may be one including the step of the securing passed data and commands between the agent system and the cloud platform using encryption.

The method may be one including the step of the communications manager handling a device being connected or disconnected in the background.

The method may be one including the step of the receiver module receiving the data via the defined data model for each device and processing the data according to assigned protocols.

The method may be one in which the database is a SQL server.

The method may be one including the step of the database storing all account, devices and configuration data as new data which can be added, changed and deleted frequently.

The method may be one including the step of the database, which is a time series database design, storing event, telemetry and diagnostic information that is reported by the devices/sensors connected to the cloud platform.

The method may be one wherein the time series database is used to support data analytics on services such as energy consumption, diagnostics.

The method may be one wherein the APIs are representational state transfer (REST) APIs.

The method may be one wherein the APIs provide data access to core cloud platform functionality.

The method may be one wherein the data access is authenticated and encrypted so that only authorised partners can gain access.

The method may be one including the step of using the API's to connect user interfaces to the cloud platform.

The method may be one wherein the user interface supports connected home services. The method may be one wherein the home services include one or more of security, video, automation, heating, lighting, rules, and social care.

The method may be one including the step of displaying event and diagnostic information via the user interface.

The method may be one wherein the user interface supports one or more of web, mobile (IOS, Android and Windows), Smart TV, tablets, and set top boxes (STB) platforms.

The method may be one wherein the new firmware includes non-intrinsic firmware.

The method may be one wherein the non-intrinsic firmware is embedded software or scripts which may be run alongside the intrinsic firmware.

The method may be one wherein the new firmware includes intrinsic firmware.

The method may be one wherein the new firmware includes camera firmware.

The method may be one wherein the agent system includes a device manager.

The method may be one including the step of the device manager converting data received via RF protocols from wireless devices to a generic format.

The method may be one including the step of the device manager converting commands received from the cloud platform to a structure understood by the device manager.

The method may be one wherein the agent system includes a rules engine.

The method may be one including the step of the rules engine controlling the system logic for connected home services.

The method may be one including the step of the rules engine allowing the agent system to make decisions based on the data that is received from sensors registered to the agent system without the need to communicate with the cloud platform.

The method may be one including the step of the rules engine allowing the agent system to operate autonomously if connection to the cloud platform is lost.

The method may be one including the step of the rules engine receiving new rules from the cloud platform via scripts.

The method may be one wherein the agent system includes a Telemetry Rules Engine.

The method may be one including the step of the Telemetry Rules Engine monitoring the flow of regularly reported telemetry data values such as energy, power, temperature, voltage, flow-rate, speed, rpm and acceleration.

The method may be one including the step of the Telemetry Rules Engine performing bounds checks which generate events if the bounds are exceeded.

The method may be one wherein the agent system includes a camera.

The method may be one including the step of the cloud platform triggering an alarm on an alarm generating device when motion is detected on the camera.

The method may be one in which the alarm is a siren.

The method may be one in which the alarm generating device is a hub.

The system may be one in which the cloud platform triggers an alarm on an alarm generating device when motion is detected on the camera.

The method may be one wherein the agent system includes a Video Communications Manager.

The method may be one including the step of the Video Communications Manager providing a persistent connection using XMPP to the cloud platform.

The method may be one including the step of the Video Communications Manager providing a persistent connection using MQTT to the cloud platform.

The method may be one including the step of the Video Communications Manager using a combination of STUN (Session Traversal Utilities for NAT (Network address translation)) and XMPP to provide a communications mechanism to negate NAT traversal and remove the need for an end user to enable port forwarding for the device.

The method may be one including the step of the Video Communications Manager using a combination of STUN (Session Traversal Utilities for NAT (Network address translation)) and MQTT to provide a communications mechanism to negate NAT traversal and remove the need for an end user to enable port forwarding for the device.

The method may be one wherein the agent system provides audio analysis functions.

The method may be one including the step of if a specific sound is detected in an audio analysis function, then the agent system generates an event that is sent to the cloud platform to be processed.

The method may be one including the step of sound packs being enabled or disabled from the cloud platform.

The method may be one wherein the agent system includes Video Stream Transmission.

The method may be one wherein the Video Stream Transmission includes the steps of receiving a video stream from a camera, and sending the stream to the cloud platform.

The method may be one in which the video stream is a Real-time Transport Protocol (RTP) video stream.

The method may be one in which the video stream is encrypted prior to sending the stream to the cloud platform.

The method may be one including the Video Stream Transmission step of use of security certificates.

The method may be one wherein the cloud platform includes video processing.

The method may be one wherein the video processing includes the step of receiving encrypted H.264 video via Secure Real-time Transport Protocol (SKIP) and then processing the received video so that it can be supported on multiple platforms.

The method may be one wherein the video processing includes the step of providing cloud video recording and clip storage.

The method may be one wherein the cloud platform includes a video receiver.

The method may be one including the steps of the video receiver receiving a video stream and then decrypting the video stream and then passing the decrypted video stream to a video proxy server to be transcoded and streamed to a requesting device.

The method may be one wherein the cloud platform includes an administration system.

The method may be one including the step of the administration system providing account, device and diagnostic information.

The method may be one wherein the cloud platform includes a messaging engine.

The method may be one including the step of the messaging engine generating and transmitting a message.

According to a third aspect of the invention, there is provided a method of audio recognition integration to a cloud-based home or commercial monitoring system, the method including operating a system comprising an agent system and a cloud platform,

the agent system including a device handler and a communications manager,

the cloud platform including components including: a receiver module; a platform management layer including a rules engine, and a database;

the method including the steps of:

(i) the agent system communicating with the receiver module via the communications manager, using a data model,

(ii) the device handler communicating with a plurality of devices each including respective firmware and a respective microphone,

(iii) the device handler communicating with the communications manager,

(iv) the receiver module receiving audio event data generated by the respective firmware on the plurality of devices based on audio received by the respective microphone, and passing audio event data to the database to be stored,

(v) the platform management layer accessing stored audio event data in the database, and

(vi) the platform management layer processing the audio event data according to the rules engine to generate output actions, commands or messaging.

An advantage is that a method of audio recognition integration to a cloud-based home or commercial monitoring system is provided.

The method may be one wherein audio analysis is an integrated component of the agent system that analyses sounds and generates audio events based on the characteristics of the sounds.

The method may be one wherein sound characteristics are categorised into sound packs.

The method may be one wherein sound packs are provided for a wide range of sounds that can be heard in the home or commercial premises, including one or more of: baby crying, fire alarm, glass breaking, aggressive voices, gunshot.

The method may be one wherein sound packs are provided that are based on the voice recognition of keywords that may be heard in the home or commercial premises.

The method may be one wherein the firmware includes audio identification software, capable of identifying specific types of sound.

The method may be one wherein the audio event data includes an audio capture file based on audio received by the respective microphone.

The method may be one wherein an audio capture file is sent to a FTP server in the cloud platform via SFTP.

The method may be one wherein output messaging is sent to designated recipients.

The method may be one wherein output messaging includes an audio file based on audio received by the respective microphone.

The method may be one wherein audio events are forwarded by the platform management layer to third party professional security monitoring service providers.

The method may be one wherein the agent system includes a Telemetry Engine which applies audio measurement metrics to an audio event.

The method may be one wherein when an applied audio measurement metric exceeds a specified value, the audio event is passed to the Communications Manager or the Rules Engine.

The method may be one wherein event detection is combined with other events in the system to get more context.

The method may be one wherein the cloud platform further includes application programming interfaces (APIs) and a user interface.

The method may be one including the step of: the APIs connecting via the user interface to at least one other cloud platform component.

The method may be one including the step of: the at least one other cloud platform component being operated by the APIs to push a command or new firmware to a connected device in the plurality of devices.

The method may be one wherein the APIs enable end-users to configure audio analysis and retrieve audio event information.

The method may be one wherein the user interface is configured to enable end-users to monitor and manage audio events on their devices.

The method may be one wherein the user interface is configured to enable one or more of:
Displaying audio events
Configuring sound packs for devices
Configuring sound packs for sensitivity
Enabling or disabling audio analysis based on premises occupancy
Configuring and enabling or disabling rules.

The method may be one including the method of any aspect of the second aspect of the invention.

According to a fourth aspect of the invention, there is provided use of the method of any aspect of the third aspect of the invention, within professional monitoring for alert verification.

A system may be provided which is configured to perform a method of any aspect of the third aspect of the invention.

According to a fifth aspect of the invention, there is provided a method of combination and correlation of audio detection events with video capture in a user interface allowing identification and retrieval of stored audio events in a timeline, the method including operating a system comprising an agent system and a cloud platform, the agent system including a device handler and a communications manager, the cloud platform including components including: a receiver module; a platform management layer including a rules engine; a database and a user interface; the method including the steps of:

(i) the agent system communicating with the receiver module via the communications manager, using a data model,

(ii) the device handler communicating with a plurality of devices each including respective firmware and a respective microphone or a respective video camera,

(iii) the device handler communicating with the communications manager,

(iv) the receiver module receiving audio event data generated by the respective firmware on a device in the plurality of devices, based on audio received by a respective microphone, and passing audio event data to the database to be stored,

(v) the receiver module receiving video data generated by the respective firmware on a device in the plurality of devices, based on video recorded by a respective video camera, and passing video data to the database to be stored,

(vi) the platform management layer accessing stored audio event data and video data in the database,

(vii) the platform management layer processing the audio event data according to the rules engine to generate output actions, commands or messaging, and

(viii) allowing users/operators via the user interface to navigate to an audio event within a video recording stored in the database.

An advantage is that there is provided a method of combination and correlation of audio detection events with video capture in a user interface allowing identification and retrieval of stored audio events in a timeline.

The method may be one in which the method step (viii) enables correlation of an audio event and video data.

The method may be one including the step of providing a navigation timeline in a web or native app interface with visual identification markers within the timeline to indicate the precise moment that an audio detection event occurred, allowing a user/operator to quickly navigate to that point within the video recording, enabling review and correlation with the events captured in the video recording at that time.

The method may be one including the step of providing integration with messaging systems so that users/operators are notified of an event marker in a video stream.

The method may be one in which a notification message contains a shortcut link to allow the user/operator to navigate directly to the video recording with a single click.

The method may be one in which the Receiver Module is a XMPP client module that receives audio events from the Communications Manager.

The method may be one in which the Receiver Module is a MQTT client module that receives audio events from the Communications Manager.

The method may be one in which audio analysis is an integrated component of the agent system that analyses sounds and generates audio events based on the characteristics of the sounds.

The method may be one wherein sound characteristics are categorised into sound packs.

The method may be one wherein sound packs are provided for a wide range of sounds that can be heard in the home or commercial premises, including one or more of: baby crying, fire alarm, glass breaking, aggressive voices, gunshot.

The method may be one wherein sound packs are provided that are based on the voice recognition of keywords that may be heard in the home or commercial premises.

The method may be one in which the firmware includes audio identification software, capable of identifying specific types of sound.

The method may be one in which the audio event data includes an audio capture file based on audio received by the respective microphone.

The method may be one in which the agent system includes a video communication manager.

The method may be one including the step of the video communication manager encapsulating audio events from a camera's firmware into XML format and sending them to the Receiver Module of the Cloud platform.

The method may be one including the step of the video communication manager directing a video stream from the camera firmware to a Video Receiver of the Cloud platform.

The method may be one including the step of the video communication manager sending video clips or live stream to the Video Receiver of the Cloud platform when there is a motion event detected by the camera or an audio event from Audio Analysis.

The method may be one including the step of the video communication manager receiving a command from the Cloud platform to Activate or Deactivate Audio Analysis on a device.

The method may be one in which the Receiver Module is a client module that receives audio events from the Video Communications Manager.

The method may be one including the step of the Receiver Module receiving a notification of an audio event from a device connected to the agent system and in response sending a command to the Video Communications Manager or to a camera device to trigger video clip capture.

The method may be one including the step of the Receiver Module sending messages to the camera firmware to start or stop video streaming.

The method may be one in which the cloud platform further includes application programming interfaces (APIs).

The method may be one including the step of: the APIs connecting via the user interface to at least one other cloud platform component.

The method may be one including the step of: the at least one other cloud platform component being operated by the APIs to push a command or new firmware to a connected device in the plurality of devices.

The method may be one in which the API's enable the user interface to do one or more of:

Set the source path of the video clip or point in time on the captured video

Configure audio analysis

Retrieve audio event information

Retrieve audio event information by sound pack category

Manage and control video camera settings.

The method may be one including a step in which the user interface is configured to enable end-users to monitor and manage audio events on their devices.

The method may be one in which the step in which the user interface is configured to enable end-users to monitor and manage audio events on their devices includes the step of performing one or more of:

Displaying audio events

Configuring sound packs for devices

Configuring sound packs for sensitivity

Enabling or disabling audio analysis based on premises occupancy

Configuring and enabling or disabling rules

Navigating a timeline to view video clips related to audio events

Displaying identifying markers for video clips related to different categories of audio event

Providing a marker clickable to immediately navigate to the video/audio event.

The method may be one including a step in which output messaging is sent to designated recipients.

The method may be one in which the output messaging includes an audio file based on audio received by the respective microphone.

The method may be one including a method of any aspect according to the second aspect of the invention.

A system may be provided which is configured to perform a method of any aspect of the fifth aspect of the invention.

According to a sixth aspect of the invention, there is provided a method of distributing customized rules, including a method of operating a system comprising an agent system and a cloud platform,

the agent system including a device handler and a communications manager,

the cloud platform including components including: a receiver module; a platform management layer including a rules engine; a database and a user interface, the method including the steps of:

(i) the agent system communicating with the receiver module via the communications manager, using a data model,

(ii) the device handler communicating with a plurality of devices each including respective firmware,

(iii) the device handler communicating with the communications manager,

(iv) the receiver module receiving event data generated by the respective firmware on the plurality of devices, and passing event data to the database to be stored,

(v) the platform management layer accessing stored event data in the database,

(vi) the platform management layer processing the event data according to the rules engine to generate output actions, commands or messaging,

(vii) receiving custom behavioural rules in the user interface;

(viii) connecting the user interface to at least one other cloud platform component, and

(ix) storing the custom behavioural rules in the at least one other cloud platform component.

An advantage is that customized rules are distributed in a system comprising an agent system and a cloud platform, which enables the behavior of part of the system to be customized.

The method may be one including the step of distributing the custom behavioural rules from the cloud platform to the agent system.

The method may be one including the step of automatically distributing the custom behavioural rules from the cloud platform to a device in the plurality of devices.

The method may be one including the step of the at least one other cloud platform component being operated by the user interface to push the custom behavioural rules to a connected device in the plurality of devices.

The method may be one wherein distribution of the custom rules does not require an upgrade to the intrinsic firmware of the host device.

The method may be one wherein the rules are distributed in a scripting language and run as a loadable application on the host device.

The method may be one including the step of creating the custom rules on a smart phone app.

The method may be one including the step of the Cloud platform deciding where to run the rules so as to ensure maximum disconnected behaviour.

The method may be one in which multiple instances of an embeddable ‘state or rules engine’ are provided that can run across multiple operating system environments including Linux and Java as an application.

The method may be one in which the rules engine is capable of identifying and applying customisable rules where the triggers are telemetry data points.

The method may be one in which the custom behavioural rules are stored in the database.

The method may be one in which the agent system includes an agent system rules engine.

The method may be one in which the agent system rules engine includes a telemetry rules engine.

The method may be one in which a custom rule may be applied to events by both the agent system Rules Engine and by the Platform Management Layer.

The method may be one in which a Rules file can be passed to the agent system Rules Engine without the need to update intrinsic firmware that is operating on the agent system.

The method may be one in which a rule describes a trigger to be a function of detected presence, or lack of presence, of an individual within a home, a zone or within a defined part of a home or zone.

The method may be one including a method of any aspect of the second aspect of the invention.

A system is provided which is configured to perform a method of any aspect of the sixth aspect of the invention.

According to a seventh aspect of the invention, there is provided a method of using sensor devices to support energy conservation, the method including operating a system comprising an agent system and a cloud platform,

the agent system including a device handler and a communications manager,

the cloud platform including components including: a receiver module; a platform management layer including a rules engine, and a database, the method including the steps of:

(i) the agent system communicating with the receiver module via the communications manager, using a data model,

(ii) the device handler communicating with a plurality of sensor devices each including respective firmware,

(iii) the device handler communicating with the communications manager,

(iv) the receiver module receiving event data generated by the respective firmware on the plurality of sensor devices, and passing event data to the database to be stored,

(v) the platform management layer accessing stored event data in the database,

(vi) the platform management layer processing the event data according to the rules engine to identify energy waste, and to generate output actions, commands or messaging which support energy conservation.

An advantage is that event data is processed according to the rules engine to identify energy waste, and to generate output actions, commands or messaging which support energy conservation.

The method may be one wherein energy waste is identified by identifying open doors or windows and ambient temperature in rooms in which temperature sensors are placed.

The method may be one wherein actions include alerting a user via push notification or via direct command from the cloud platform to control the heating in the room e.g. via thermostatic radiator valves (TRV) or a programmable room thermostat (PRT).

The method may be one wherein actions include a controllable device such as a door/window closer, garage door closer being controlled as required.

The method may be one including a method of any aspect according to the second aspect of the invention.

There is provided a system configured to perform a method of any aspect of the seventh aspect of the invention.

According to an eighth aspect of the invention, there is provided a method of using cloud connected safety sensors to monitor and alert on environmental conditions within a building for assisted living applications, and onward integration with third party services, the method including a method of operating a system comprising an agent system and a cloud platform, the agent system including a device handler and a communications manager, the cloud platform including components including: a receiver module; a platform management layer including a rules engine; a database; the method including the steps of:

(i) the agent system communicating with the receiver module via the communications manager, using a data model,

(ii) the device handler communicating with a plurality of devices each including respective firmware,

(iii) the device handler communicating with the communications manager,

(iv) the receiver module receiving event data generated by the respective firmware on the plurality of devices, and passing event data to the database to be stored,

(v) the platform management layer accessing stored event data in the database,

(vi) the platform management layer processing the event data according to the rules engine to generate output actions, commands or messaging,

An advantage is that monitoring and alerting on environmental conditions within a building for assisted living applications, and onward integration with third party services, is provided.

The method may be one wherein the plurality of devices include devices which monitor environmental conditions.

The method may be one in which the method enables monitoring of an old or otherwise vulnerable person, or enables child and/or baby monitoring and/or monitoring school children coming home.

The method may be one in which the method enables potential safety, health or medical issues to be identified by the collection of device sensor data.

The method may be one in which the output messaging includes alert notifications warning of possible safety problems to carers including relatives or professional monitoring service providers.

The method may be one in which a user can define rules within the Platform Management Layer that are relevant to assisted living scenarios.

The method may be one in which the rules include movement, opening/closing of windows or doors, absence of movement, or absence of a sensor opening/closing.

The method may be one in which at least some of the rules have time parameters associated with a trigger.

The method may be one in which the event data can be viewed via multiple User Interfaces (UIs) via the use of API's that allow secure access to the cloud platform database.

The method may be one in which if a rule for an assisted living scenario is triggered then the end user is notified via a Messaging Engine.

The method may be one including a method of any aspect according to the second aspect of the invention.

A system is provided which is configured to perform a method of any aspect according to the eighth aspect of the invention.

According to a ninth aspect of the invention, there is provided a method of allowing security monitoring services to be booked, the method including operating a system comprising an agent system and a cloud platform,

the agent system including a device handler and a communications manager,

the cloud platform including components including: a receiver module; a platform management layer including a rules engine; a database and a user interface, the method including the steps of:

(i) the platform management layer receiving a booking for security monitoring services via the user interface;

(ii) the agent system communicating with the receiver module via the communications manager, using a data model,

(iii) the device handler communicating with a plurality of devices each including respective firmware,

(iv) the device handler communicating with the communications manager,

(v) the receiver module receiving event data generated by the respective firmware on the plurality of devices, and passing event data to the database to be stored,

(vi) the platform management layer accessing stored event data in the database,

(vii) the platform management layer processing the event data according to the rules engine to generate output actions, commands or messaging, in accordance with the booking.

An advantage is that security monitoring services can be booked, and actions, commands or messaging, may be generated by the system in accordance with the booking.

The method may be one wherein the booking includes receiving user details for premises to be monitored, and wherein the premises are monitored.

The method may be one wherein the booking includes receiving a time period for the security monitoring services to be provided, and wherein the security monitoring services are provided for the time period.

The method may be one wherein messaging is provided based on customisable rules.

The method may be one wherein the cloud platform includes APIs.

The method may be one in which the APIs are connectable via the user interface to the database, and wherein an API is used to insert the relevant booking details into the database.

The method may be one wherein OSS/BSS Integration is used in order to integrate with the security monitoring provider.

The method may be one wherein when an event is received from a device through the Receiver, the Platform Management Layer determines if the event is a supported event that needs to be forwarded to the security monitoring provider.

The method may be one including a method of any aspect according to the second aspect of the invention.

There is provided a system configured to perform a method of any aspect of the ninth aspect of the invention.

According to a tenth aspect of the invention, there is provided a method of using a contactless operation to identify and connect a sensor device to a device handler for cloud based monitoring and alerting, including operating a system comprising an agent system and a cloud platform,

the agent system including a device handler and a communications manager,

the cloud platform including components including: a receiver module; a platform management layer including a rules engine; a database and a user interface; the method including the steps of:

(i) identifying a plurality of sensor or actuator devices to the device handler using contactless operations using the user interface;

(ii) the agent system communicating with the receiver module via the communications manager, using a data model,

(iii) the device handler communicating with the plurality of sensor or actuator devices each including respective firmware,

(iv) the device handler communicating with the communications manager,

(v) the receiver module receiving event data generated by the respective firmware on the plurality of devices, and passing event data to the database to be stored,

(vi) the platform management layer accessing stored event data in the database,

(vii) the platform management layer processing the event data according to the rules engine to generate output actions, commands or messaging.

An advantage is that sensor devices may be quickly and easily registered to the system.

The method may be one wherein a contactless operation comprises scanning a QR (Quick Response) code on a sensor or actuator device.

The method may be one wherein a contactless operation comprises using NFC (Near Field Communications) in relation to a sensor or actuator device.

The method may be one wherein the user interface is provided on a mobile device eg. smartphone or tablet.

The method may be one wherein the cloud platform includes APIs.

The method may be one wherein the user interface sends network parameters of the identified devices using APIs of the cloud platform to the receiver module.

The method may be one wherein the receiver module passes information of the identified devices to platform management layer.

The method may be one wherein the platform management layer updates the database with the information.

The method may be one including a method of any aspect according to the second aspect of the invention.

There is provided a system configured to perform a method of any aspect according to the tenth aspect of the invention.

According to an eleventh aspect of the invention, there is provided a method of providing interchangeable Local or Cloud control of the same device depending on a user's location, the method including operating a system comprising an agent system and

a cloud platform,

the agent system including a device handler and a communications manager,

the cloud platform including components including: a receiver module; a platform management layer including a rules engine; a database; the method including the steps of:

(i) when a user control device is not on the same local area network as a connected device, the connected device is controllable remotely by the control device using the cloud platform;

(ii) when the user control device is on the same local area network as the connected device, the connected device is controllable locally by the control device using the agent system;

(iii) the agent system communicating with the receiver module via the communications manager, using a data model,

(iv) the device handler communicating with a plurality of connected devices each including respective firmware, the plurality of connected devices including the connected device;

(v) the device handler communicating with the communications manager,

(vi) the receiver module receiving event data generated by the respective firmware on the plurality of devices, and passing event data to the database to be stored,

(vii) the platform management layer accessing stored event data in the database,

(viii) the platform management layer processing the event data according to the rules engine to generate output actions, commands or messaging.

An advantage is that the system provides interchangeable Local or Cloud control of the same device depending on a user's location.

The method may be one wherein when the user control device is on the same local area network as the connected device, the connected device is controllable locally by the control device, by device commands which are sent directly from the control device to the Communications Manager.

The method may be one wherein the device commands are passed from the communications manager to a Device Manager in the agent system which in turn converts the commands, which are sent by the device handler to the connected device.

The method may be one wherein a state of the connected device is returned to the Device Handler and Device Manager.

The method may be one wherein the communications manager sends state information to the receiver module to ensure that the cloud platform is synchronized.

The method may be one wherein the cloud platform includes application programming interfaces (APIs), and a user interface, and the connected device status is stored in the database.

The method may be one wherein the connected device status is viewable in the user interface by accessing the database via the APIs.

The method may be one including a method of any aspect according to the second aspect of the invention.

There is provided a system configured to perform a method of any aspect according to the eleventh aspect of the invention.

Aspects of the invention may be combined. Computer program products are provided which are executable to perform respective method aspects of the invention.

### BRIEF DESCRIPTION OF THE FIGURES

Aspects of the invention will now be described, by way of example(s), with reference to the following Figures, in which:

FIG. 1 shows an example technical architecture.

FIG. 2 shows an example of a system for audio recognition integration to a cloud based (home/commercial) monitoring system, and use within professional monitoring for alert verification.

FIG. 3 shows an example of a system which enables the combination of video footage and audio detected events stored on a cloud platform on a variable timeline.

FIGS. 4A & 4B show an example of a system which allows distributed custom generated rules.

FIGS. 5A & 5B show an example of a system which enables the use of telemetry and/or event data received from RF connected security devices connected to internet cloud services via a gateway/hub to support energy conservation.

FIGS. 6A & 6B show an example of a web based system allowing professional security monitoring services to be booked by consumers on a pay as you go (PAYG) basis.

FIGS. 7A & 7B show an example of a system in which interchangeable and dynamic Local or Cloud control of the same device depending on users location is provided.

### DETAILED DESCRIPTION

Cloud computing is a form of Internet-based computing that provides shared processing resources and data to computers and other devices on demand. Cloud computing can provide on-demand access to a shared pool of configurable computing resources (e.g., networks, servers, storage, applications and services) which can be rapidly provisioned and released with minimal management effort. Cloud computing and storage solutions provide users and enterprises with various capabilities to store and process their data in third-party data centers.

In electronic systems and computing, firmware is a type of software that provides control, monitoring and data manipulation of engineered products and systems. Typical examples of devices containing firmware are embedded systems (such as traffic lights, consumer appliances, remote controls and digital watches), computers, computer peripherals, mobile phones, and digital cameras. The firmware contained in these devices provides the low-level control program for the device.

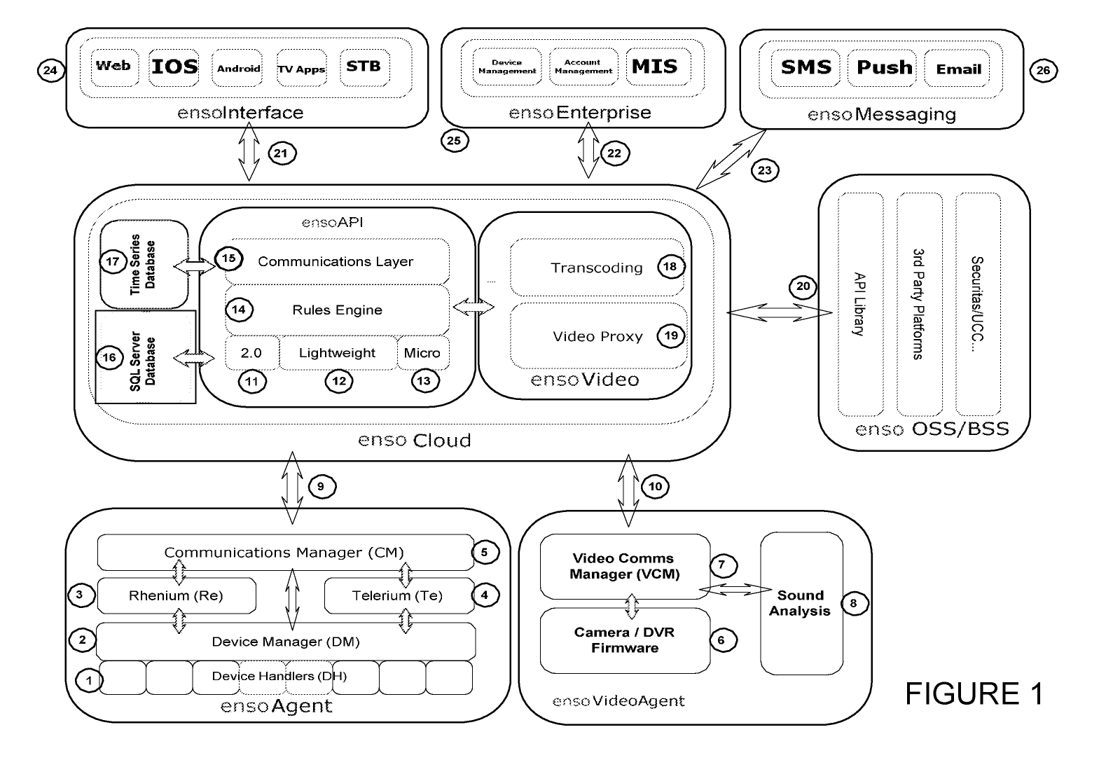

Services, technologies and processes may be combined, for example in order to supply Intamac's propositions. A diagram detailing an example technical architecture is provided in FIG. 1. Technology ‘building blocks’ may be used in the delivery of e.g. Intamac's products and services; examples may be understood with reference to FIG. 1. We provide a description of technology ‘building blocks’. We provide descriptions of various applications/services along with the technology building blocks that may be used to build the respective application/service.

### Technical Building Blocks

The numbering of the technical building blocks may be understood with reference to FIG. 1, which is provided by way of example.

### (1) Device Handler

A device handler is provided. The device handler may be provided as an embedded software module. The device handler may control an interaction between ensoAgent system software and devices (e.g. wireless devices) in order to manage communication, e.g. radio frequency (RF) communication. A variety of radio frequencies may be supported such as Zigbee, Z-Wave, 868 Mhz. Bluetooth etc. A device handler may abstract command messages from the platform so as to be radio technology agnostic.

### (2) Device Manager

A device manager is provided. This software module may provide an abstraction layer between various RF device handlers and platform communications modules and rules engines. The device manager may ensure that data received via RF protocols from wireless devices is converted to a generic format to be handled by the ensoAgent system software. The device manager may also handle any commands received from the platform and rules engines ensuring that they are converted to the correct command structure required for the rules engine or device manager.

### (3) Rules Engine

A Rules Engine, which we may refer to as ‘Rhenium’ (Re), is provided. This software may control the system logic for connected home services. This may allow the gateway to make decisions based on the data that is received from registered sensors without the need to communicate with the platform. For some services, the Rules Engine allows the gateway to operate autonomously if connection to the platform is lost. In an example, new rules can be transferred to the rules engine from the platform via scripts.

### (4) Telemetry Rules Engine

A Telemetry Rules Engine, which we may refer to as ‘Telerium’ (Te), is provided. This software may monitor the flow of regularly reported data values such as energy, power, temperature, voltage, flow-rate, speed, rpm and acceleration. Bounds-checks can be set to put limits e.g. low (floor) limits, high (ceiling) limits, and generate EVENTS if the bounds are exceeded. The Telemetry Rules Engine may also need to check for missing data reporting events up to the Rules Engine.

### (5) Communications Manager

A Communications Manager is provided. This software controls communication e.g. with the Intamac platform. Extensible Markup Language (XML) may be the data-description language used to pass data and commands to and from the gateway. This module may also handle the internal communication with the rules-engine and device handler. This module may also handle a device being connected or disconnected in the background. This design architecture allows the (e.g. three) functional blocks to be developed and features added without affecting (e.g. two) other core aspects of the application, in an example. A combination of XML and JavaScript Object Notation (JSON) may be used to describe data and encapsulate it, and these may then be exchanged between the server and client sides using the Extensible Messaging and Presence Protocol (XMPP) or using MQTT (formerly Message Queue Telemetry Transport) protocol. This connection may also be secured using encryption e.g. Transport Layer Security (TLS) or Secure Sockets Layer (SSL), so all data transferred is encrypted.

### (6) Camera Firmware

Embedded software may be deployed on a camera. For example, Intamac has developed embedded software that can be deployed on any camera that uses ONVIF (Open Network Video Interface Forum) or PSIA (Physical Security Interoperability Alliance) for external communication. Embedded software may be integrated alongside the camera's intrinsic firmware and may control the communication between the network camera and the cloud platform. The cloud platform may manage alerts and tie video into the event in the platform. The cloud platform may check audio text in use cases. The cloud platform may allow the platform to trigger a siren on a hub when motion is detected on a camera (or in audio analytics). Any command supported, e.g. within the ONVIF or PSIA protocol, can be sent from the cloud, received by the ensoAgent system video software and then passed to the camera firmware via the relevant application programming interface (API) calls. The communication between the platform and the camera may be secured using encryption.

We refer to a device's core firmware (e.g. that supplied by its manufacturer) as its intrinsic firmware. A device's firmware includes the device's intrinsic firmware plus additional firmware such as embedded software or scripts which may be run alongside the intrinsic firmware.

### (7) Video Communications Manager

A Video Communications Manager is provided. A persistent connection using XMPP or MQTT may be provided by this embedded software module. The video communications manager may use a combination of STUN (Session Traversal Utilities for NAT (Network address translation)) and XMPP or MQTT to provide a communications mechanism to negate NAT traversal and remove the need for an end user to enable port forwarding for the device. All commands sent from the cloud platform (or locally) may be handled by this embedded software module. Video conference technology may be used for security cameras and managing remote access securely. This is better than traditional closed circuit systems.

### (8) Audio Analysis

Any device that has a microphone implemented can be used to provide alerts based on a specific audio being detected. If a specific sound is detected (e.g. smoke alarm, baby cry, car alarm, gunshot, aggression) then the ensoAgent system and ensoVideoAgent system embedded software may generate an event that is sent to the cloud platform to be processed. This event can also be used as a trigger for a local rule to be activated. The ‘sound packs’ may be enabled and disabled from any user interface or platform process that supports the functionality.

### (9) Data Models & Asset Files Data Models

Data-models are provided such as to cater for all aspects of security, heating, lighting, automation of locks and other devices, for example using a combination of XML and JSON to describe and represent the data. Intamac has developed data-models to cater for all aspects of security, heating, lighting, automation of locks and other devices using a combination of XML and JSON to describe and represent the data. Data-models may provide a sophisticated abstraction making it possible to bring data together into a common form regardless of the underlying source or protocols which are used to communicate between devices. The transfer protocol can also be changed to accommodate the deployment of the platform communications module onto devices that have reduced processing power and storage. Separation of a communications manager allows a communications interface which can be smaller for constrained devices.

### Asset Files

A system of downloadable asset files is provided. This may be used to transfer larger items of data such as packages of rules, audio files and models and new firmware updates.

### (10) Video Stream Transmission

This embedded software module may receive the Real-time Transport Protocol (RTP) video stream from a camera, e.g. any camera that supports ONVIF/PSIA protocols, and may encrypt the stream prior to sending to the platform. The embedded software developed by Intamac encrypts the video stream using Secure Real-time Transport Protocol (SRTP) before sending to the cloud platform from transcoding thus ensuring that the video data cannot be intercepted and decoded. An advantage is that the platform may manage the trust to the camera. Implementation may include use of security certificates.

### (11), (12), (13) Receiver/Device Management Applications

When data is transferred from the device it may be handled on the cloud platform by a suite of Receiver applications. These applications may receive the data via the defined data models for each device and process the data according to the assigned protocols. Commands to and from the connected devices may be handled at this level by the Device Management applications. These .NET applications may be designed to be fully scalable so that increases in the number of connected devices can be handled accordingly with no loss of performance or connectivity.

### (14) Platform Management Layer

A platform rules engine is provided. Server side business logic used to support the services supplied by Intamac may be contained in the platform rules engine. All the server side business logic used to support the services supplied by Intamac may be contained in the platform rules engine. The design of the applications is such that new propositions can be defined and deployed rapidly using a set of rules/processes. This generic approach allows new functionality to be implemented to support any connected home service. Integration may be provided with the receiver layer and communications module to process device data and output actions/commands/messaging as specified. Device behavior may be changed by sending it a new rules file. The platform may decide which rules can and/or should be sent to the device to ensure maximum chance of the device working while disconnected.

### (15) Platform Communications Layer

A platform communications layer is provided. Any information/data that needs to be sent to the end user may be handled by the platform communications layer. The business logic will process an incoming event or request and the outcome of this will often be a request to the communications layer to send the result to the end user in a variety of forms, such as push notifications, Short Message Service (SMS), email and Simple Mail Transfer Protocol (SMTP) amongst others.

### (16), (17) Database Storage/Design

Distinct types of database may be deployed. There are two distinct types of database deployed to support the Intamac solutions. Each may have a distinct schema/design. The first type is a SQL server which stores all account, devices and configuration data as new data which can be added, changed and deleted frequently. The second is a time series database design which stores the vast amount of event, telemetry and diagnostic information that can be reported by the devices/sensors connected to the cloud platform. The time series database can be used to support data analytics on services such as energy consumption, diagnostics etc. Therefore there is provided a split of relational and time series data according to purpose.

### (18) Video Processing

Video Processing may be provided. The platform may receive encrypted H.264 video via Secure Real-time Transport Protocol (SRTP) and then process the stream so that it can be supported on multiple platforms. For IOS (a mobile operating system created and developed by Apple Inc.) the stream is transcoded into HTTPS (also called HTTP over TLS, HTTP over SSL, and HTTP Secure) Live streaming (HLS); for Android it is converted to Real Time Streaming Protocol (RTSP) and for web applications it is converted to SKIP. (HTTP is Hypertext Transfer Protocol). This ensures that a platform can be supported using a secure video stream. A suite of video processing software also provides cloud video recording and clip storage.

### (19) Video Receiver

Intamac has developed proprietary software to handle the encrypted SRTP stream from a network camera on which the ensoVideoAgent system is deployed. The stream is received, decrypted and then passed to the video proxy server to be transcoded and streamed to the requesting device.

Cloud Video Recording is innovative instead of storing data locally. An advantage is that the video recording doesn't need to come from the camera itself. Traditional video monitoring solutions capture recorded video onto a storage device located at the premises. Remote playback of this video from the local storage to a remote device such as a mobile or web browser is a known effect, however in a cloud video recording solution, camera video is sent directly to the cloud and stored in the cloud rather than on premise, either as a continuous stream or in response to an event. An advantage of this solution over the traditional on-site storage solution is that while the local storage device may be stolen or damaged during a break-in, which damages the captured video and thus renders the system useless, when the video is instead captured securely in the cloud, this issue is avoided. In addition, the cost of cloud storage is shared amongst many users and the user need only pay for the storage that is used, whereas for a local storage solution, the user must effectively pay for sufficient storage to meet the worst case recording needs of his premises.

### (20) OSS/BSS Integration

Operations support system/business support system (OSS/BSS) integration requires that data be passed between third party account management, billing, logistics, single sign on and management information. A set of representational state transfer (REST) API's have been developed to support this functionality. Intamac has integrated with multiple partners using these API's in order to provide additional services such as manned response for security. Integration with multiple enterprise Customer relationship management (CRM) solutions has been achieved and the API suite provides the full end to end solution for multiple connected home services promoted by service providers.

### (21), (22), (23) API

A library of REST API's may provide data access to the core platform functionality. This access may be authenticated and encrypted so that only authorised partners can gain access. The API's may be used by the Intamac Development team to connect the user interfaces to the cloud platform. This approach may also provide third party developers a software development kit (SDK) so that business partners can develop and deploy user interfaces independently. In an example, with over 300 proprietary API calls available, the full functionality of connect home services may be supported.

### (24) User Interfaces

End user interfaces for multiple platforms are provided in order to support the connected home services supplied. These services may include security, video, automation, heating, lighting, rules, and social care. Event and diagnostic information may also be displayed via these user interfaces (UI's). Platforms supported may include web, mobile (IOS, Android and Windows), Smart TV, tablets, and set top boxes (STB).

(25) Administration System

Each of the Intamac services may be supplied with an administration system which may provide support teams with the necessary tools to support a proposition. This is an enterprise solution which may provide account, device and diagnostic information so that any issues can be resolved by the support personnel. Device maintenance is included which may enable new firmware to be pushed to any connected device. A hierarchical administration system is provided, and different roles can be defined to provide specific levels of access for the support personnel.

### (26) Messaging Engine

The platform messaging engine can support multiple messaging formats including SMS, email, push notification and telephony (CTI: Computer telephony integration). This technical building block may include the software required to integrate with third party services such as SMS as well as the relevant push notification service for both IOS and Android.

### Audio Recognition Integration to a Cloud Based (Home/Commercial) Monitoring System; Use Within Professional Monitoring for Alert Verification

There is provided an internet connected service that uses audio detection technology within domestic and/or commercial internet connected monitoring products, which may include the integration with third party professional monitoring service providers.

The service may involve the deployment of third party audio identification software, capable of identifying specific types of sound, to run on monitoring devices (including for example internet protocol (IP) cameras, alarm panels, IP gateways, light-switches, smart electrical plugs—in fact any suitable target device with a built in microphone).

Once the specific sound profiles have been identified (e.g. smoke alarm, gunshot, baby crying, glass breaking) an alert message may be collected by the client software running in the same device as the audio identification software, or running on a separate device connected to that device e.g. across a local area network (wireless or wired).

This alert message (SMS/push/email) may then be transmitted via wired or wireless internet connectivity to a cloud platform from where a notification of the detected sound can be sent to designated recipients (e.g. home owner and/or facilities manager and/or professional monitoring service provider).

There is also provided for an audio capture file (e.g. a sound clip of variable length) of the detected sound to be sent along with the alert notification to allow verification of the sound based alert event. The sound clip may be transferred to the platform securely using SFTP.

There is also provided for a sound detection event to be used as a variable in a (e.g. ‘double knock’) security verification process by professional security monitoring service providers (for example in combination with a detected door opening event or motion detection event, which may be identified by other connected devices), in which a sound detection event is confirmed or supported in some way.

In an example, an audio event can trigger something in the system elsewhere, i.e. not on the hub or the camera that the event was detected on. In an example, event detection can be combined with other events in the system to get more context.

### Technical Implementation Example

An example technical implementation is described. The numbering of the technical building blocks may be understood with reference to FIG. 1, which is provided by way of example.

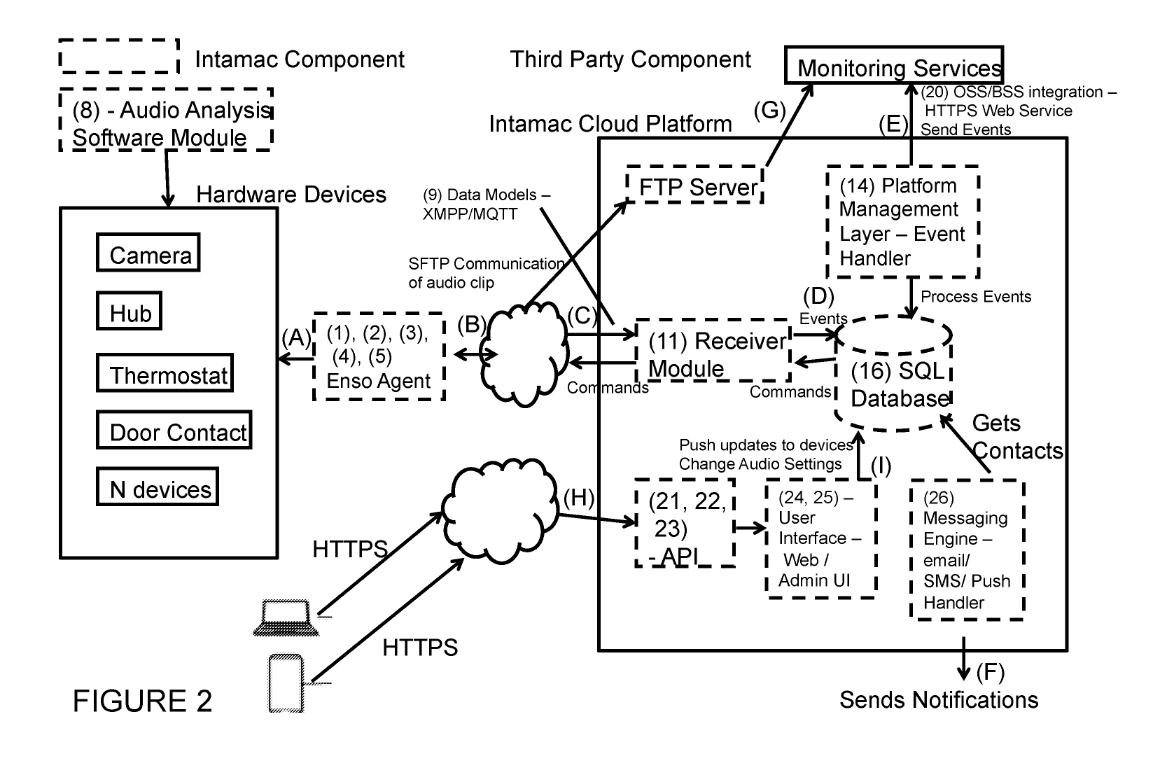

FIG. 2 shows an example of a system for audio recognition integration to a cloud based (home/commercial) monitoring system, and use within professional monitoring for alert verification. FIG. 2 uses the same numbering for technical blocks as in FIG. 1.

### (2) Device Manager

A Device Manager accepts audio events from the microphones in devices connected to the system and converts the audio events to a proprietary format that is used by an ensoAgent system and an ensoVideoAgent system.

From the Device Manager, audio events are passed to the Rules Engine (Rhenium) and Telemetry Engine (Tellerium). See flow (A) in FIG. 2, by way of example.

### (8) Audio Analysis

Audio analysis is an integrated component of an ensoAgent system and an ensoVideoAgent system that analyses sounds and generates audio events based on the characteristics of the sounds. Sound characteristics may be categorised into sound packs.

Sound packs can be created for a wide range of sounds that can be heard in the home or commercial premises, for example; baby crying, fire alarm, glass breaking, aggressive voices, gunshot, etc.

In addition, sound packs can be created that are based on the voice recognition of keywords that may be heard in the home or commercial premises. Examples of keywords that sound packs can be created for include; “Help, help, help,” “Fire,” “Call the police,” “Stop hurting me,” etc.

### (3) Rules Engine (Rhenium)

The Rules Engine receives the output of the audio analysis (8) and determines whether or not it should be forwarded to the ensoCloud platform. This decision is based on factors such as:
Business logic criteria, for example is the user account authorised to use Audio Recognition and also
End user configured criteria (if this event, then this action), for example when baby crying is detected, then turn on a light that is connected to the system. Furthermore, an audio clip of the event can be requested from the triggering device and sent via SFTP to the ensoCloud platform.

Any audio events that are allowed by the Rules Engine are passed to the Communications Manager.

### (4) Telemetry Engine (Tellerium)

The Telemetry Engine applies audio measurement metrics to the audio event. For example, the Telemetry Engine measures the volume of the audio event, the frequency of the sound, the duration of the sound, etc. Where the measured parameter exceeds specified values, the audio event is passed to the Communications Manager or the Rules Engine.

### (5) Communications Manager

The Communications Manager may encapsulate audio events into XML format and send them to the Receiver Module of the ensoCloud platform. See Flow (B) in FIG. 2, by way of example.

The Communications Manager may also receive commands from the ensoCloud platform to Activate/Deactivate Audio Analysis sound packs on end devices. See Flow (B) in FIG. 2, by way of example.

### (9) Data Models

Data models are specified for all types of audio event that are detected by devices and passed to the ensoCloud platform.

Audio data models can be encapsulated into the data models for multiple devices. For example the same audio data model for say gunshot sounds can be used in the data model for any device with a microphone, e.g. thermostat, door contact, camera, etc.

The data model is a proprietary format that is the interface into the ensoCloud platform for all audio events. This may sit between the Receiver Module and an ensoAgent system or an ensoVideoAgent system. MQTT protocol may be used. See Flow (C) in FIG. 2, by way of example. MQTT (formerly Message Queue Telemetry Transport), referred to in FIG. 2, is an ISO standard (ISO/IEC PRF 20922) publish-subscribe based “light weight” messaging protocol for use on top of the TCP/IP protocol. It is designed for connections with remote locations where a “small code footprint” is required or the network bandwidth is limited.

### (11) Receiver Module

The Receiver Module is a XMPP or MQTT client module that receives audio events from the Communications Manager based on the defined audio data model. See Flow (D) in FIG. 2, by way of example.

The Receiver Module may convert audio events received within XMPP or MQTT messages from the Communications Manager into the SIA (Security Industry Association) standard event format.

### (14) Platform Management Layer

The Platform Management Layer (platform rules engine) processes audio events that have been passed to the ensoCloud platform. From here, audio events can be forwarded to 3rd party professional security monitoring service providers. Decisions can be applied to audio events using:—
Business logic rules applied to audio events, for example, send all gunshot audio events to a 3rd party professional security monitoring service provider; see Flow (E) in FIG. 2, by way of example.
End-user configured rules applied to audio events, for example if a baby crying audio event has been received, then send push notification to an end-user; see Flow (F) in FIG. 2, by way of example.

### (16) SQL Database Design

There is a database table structure in place to identify sound packs, links to sound pack files, default sensitivity, category information etc.

### (20) OSS/BSS Integration

The ensoCloud platform can be integrated with 3^{rd} party professional monitoring service providers so that audio events can be monitored and responded to at homes and commercial premises. As well as alerting that a specified type of audio event has occurred (see Flow (E) in FIG. 2, by way of example) an audio clip can also be sent to the monitoring service, so that the audio event can be listened to (see Flow (G) in FIG. 2, by way of example). The OSS/BSS integration enables end-user contact information and location information to be synchronised between the two systems.

### (21-23) API

API's provide the integration with User Interfaces (web browser and smartphone applications). They enable end-users to configure audio analysis and retrieve audio event information.

### (24) User Interface (UI) UI's are configured to enable end-users to monitor and manage audio events on their devices (see Flow (H) in FIG. 2, by way of example), for example:—

Display audio events
Configure sound packs for devices
Configure sound packs for sensitivity
Enable or disable audio analysis based on premises occupancy
Configure and enable/disable rules.

### (25) Administration System

The Administration System can be used to upload new sound packs, for example an additional sound pack that detects a doorbell. The Administration System can dynamically change the system by adding the new sound pack into operation. See Flow (I) in FIG. 2, by way of example.

The Administration System can also be used to configure the sensitivity of sound packs down to a per user basis. The Administration System can also be used to view reports that are generated from collected data such as the number of alerts raised over time in order to provide trend analysis, identify accounts that are frequently raising alerts etc.

### (26) Messaging Engine

The Messaging Engine reads from the database to determine which end-user a message should be sent to and in which format, in response to the occurrence of an audio event being received. Based on user preferences, notifications can be received by email, SMS or push notification. See Flow (F) in FIG. 2, by way of example.

The Messaging Engine integrates with both Android and iOS push notification services. An end user would receive a notification alerting them of various triggered sound packs such as (baby cry, gunshot, aggression, keyword, etc.).

### Combination and Correlation of Audio Detection Events with Video Capture in an Easy to Navigate UI Allowing for Identification and Retrieval of Stored Audio Events in a Timeline

There is provided a system, and a related method, which enables the combination of video footage and audio detected events stored on a cloud platform on a variable timeline. This system, and a related method, may allow users/operators to quickly navigate to a sound detected event within a continuous cloud based video recording, enabling correlation of both events for more accurate diagnosis and verification.

The system, and a related method, may provide a navigation timeline in a web or native app interface with visual identification markers within the timeline to indicate the precise moment that an audio detection event occurred (e.g. based on identification of specific sound profiles) allowing a user/operator to quickly navigate to that point within the video recording so that they can review and correlate with the events captured in the video recording at that time.

The system, and a related method, can also include integration with messaging systems (SMS/push/email) so that users/operators can be notified of the event marker in the video stream and the message can contain a shortcut link to allow the user/operator to navigate directly to the video recording with a single click.

### Technical Implementation Example

An example technical implementation is described. The numbering of the technical building blocks may be understood with reference to FIG. 1, which is provided by way of example.

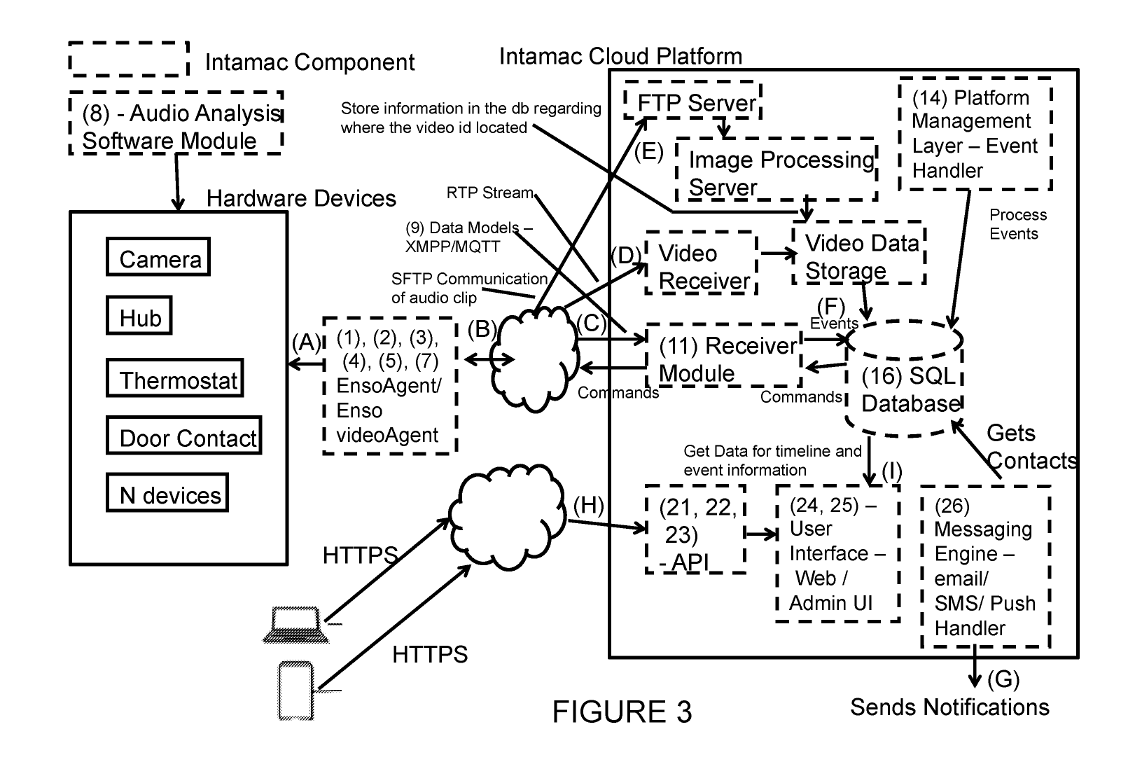

FIG. 3 shows an example of a system for combination and correlation of Audio Detection Events with Video Capture in an easy to navigate UI allowing for identification and retrieval of stored audio events in a timeline. FIG. 3 uses the same numbering for technical blocks as in FIG. 1.

### (8) Audio Analysis

Audio analysis may be an integrated component of an ensoAgent system and an ensoVideoAgent system that analyses sounds and generates audio events based on the characteristics of the sounds. Sound characteristics may be categorised into sound packs.

Sound packs can be created for a wide range of sounds that can be heard in the home or commercial premises, for example; baby crying, fire alarm, glass breaking, aggressive voices, gunshot, etc.

In addition, sound packs can be created that are based on the voice recognition of keywords that may be heard in the home or commercial premises. Examples of keywords that sound packs can be created for include; “Help, help, help,” “Fire,” “Call the police,” “Stop hurting me,” etc.

### (7) Video Communications Manager

The Video Communications Manager may have the following functionality:—
Encapsulates audio events from the camera firmware into XML format and sends them to the Receiver Module of the ensoCloud platform. See Flow (C) in FIG. 3, for example.
Manages the connection to the ensoCloud platform's Receiver using XMPP or

MQTT protocol (see Flow (C) in FIG. 3, for example), to the Video Receiver using RTP (see Flow (D) in FIG. 3, for example) and the FTP server using SFTP protocol (see Flow (E) in FIG. 3, for example)
Directs RTSP (a standard video format) video stream from the camera firmware to the Video Receiver (see Flow (D) in FIG. 3, for example).
Sends video clips or live stream to the Video Receiver when there is a motion event detected by the camera or an audio event from Audio Analysis (see Flow (E) in FIG. 3, for example).
Receives commands from the ensoCloud platform to Activate/Deactivate Audio Analysis sound packs on end devices. See Flow (C) in FIG. 3, for example.

### (9) Data Models

There is provided a proprietary data model that is compatible with all types of camera connected to the ensoCloud platform. This may sit between the Receiver Module and ensoVideoAgent system. See Flow (C) in FIG. 3, for example.

Audio data models can be encapsulated into the camera data models. The data model may describe the current state of sound pack or camera.

### (11) Receiver Module

The Receiver Module may be a XMPP or MQTT client module that may receive audio events from the Video Communications Manager e.g. based on a defined camera data model. See Flow (F) in FIG. 3, for example. The Receiver Module may convert audio events received within XMPP or MQTT messages from the Communications Manager into the SIA (Security Industry Association) standard event format. The Receiver Module may receive notification of audio events from other devices connected to the system and may send a command to the Video Communications Manager or a camera to trigger video clip capture. The Receiver Module may send and receive messages from the ensoCloud platform to the camera firmware to start and stop video streaming.

### (14) Platform Management Layer

The Platform Management Layer (platform rules engine) may process audio events that have been passed to the ensoCloud platform. Decisions can be applied to audio events using, for example:—
Business logic rules applied, for example, when an audio event has occurred so as to request a video clip from the camera.
End-user configured rules applied, for example if a baby crying audio event has been received, then sending a push notification to an end-user; see Flow (G) in FIG. 3, for example.

### (16) SQL DB Design

There is a database table structure to identify a point in time that links video clip data and audio event data. There is a database table structure in place to identify sound packs, links to sound pack files, default sensitivity, category information etc.

### (21-23) API API's provide the integration with User Interfaces (e.g. web browser and smartphone applications). See Flow (H) in FIG. 3, for example. API's may enable the UI to:

Set the source path of the video clip or point in time on the captured video
Configure audio analysis
Retrieve audio event information
Retrieve audio event information by sound pack category
Manage and control video camera settings.

### (24) User Interface

UI's may be configured to enable end-users to monitor and manage audio events on their devices (see Flow (I) in FIG. 3, for example), for example:—
Display audio events
Configure sound packs for devices
Configure sound packs for sensitivity
Enable or disable audio analysis based on premises occupancy
Configure and enable/disable rules
Navigate timeline to view video clips related to audio events
Display identifying markers for video clips related to different categories of audio event
Marker is clickable to immediately navigate to the video/audio event.

### (26) Messaging Engine

The Messaging Engine may read from the database to determine which end-user a message should be sent to, and in which message format, in response to the occurrence of an audio event being received. Based on user preferences, notifications can be received by email, SMS or push notification, for example. See Flow (G) in FIG. 3, for example.

The Messaging Engine may integrate with both Android and iOS push notification services. An end user may receive a notification alerting them of various triggered sound packs such as (baby cry, gunshot, aggression, keyword, etc.)

### Distributed Custom Generated Rules

There is provided a system, and a related method, which allows custom behavioural (e.g. cause and effect) rules relating to a home/commercial monitoring, assisted living, home/commercial automation system (or similar) to be created by a user/operator via an interface (e.g. web or mobile app interface) such that the rules can be stored and actioned from an internet cloud platform and also in which the custom rules can be automatically distributed by the cloud system so that where useful/appropriate they can be hosted and run locally within a home/premise device such as a gateway/router or other host device.

The system, and a related method, may enable custom rules to be generated and distributed to one or more local devices within premises and the system may be able to continue to work in the event that internet connectivity to the host device is lost (in which case there is therefore no longer a dependency on the internet for the enactment of local rules).

Distribution of the custom rules does not require an upgrade to the intrinsic firmware of the host device; instead the rules may be distributed in a scripting language and run as a loadable application on the host device across any operating system.

The system, and a related method, may use a software based ‘state engine’ that can be deployed and which can receive modified ‘rules’ from a cloud platform or which can receive rules that can be created on a smart phone app or other device and pushed to the Rules Engine without the need for an upgrade to the intrinsic firmware of the host device. This therefore may extend or modify the device behavior without an upgrade to the intrinsic firmware. A Cloud platform can decide where to run the rules so as to ensure maximum disconnected behaviour.

The system, and a related method, may allow multiple instances of an embeddable ‘state or rules engine’ that can run across multiple operating system environments including Linux and Java as an application to enable Set Top Boxes, Gateways, Hubs, Alarm Panels, Routers and other similar devices to operate as aggregation devices for connected Home Automation, Home Monitoring, Assisted Living and similar services and that can receive modified ‘rules’ from a cloud platform or that can be created on a smart phone app or other device and pushed to the Rules Engine without the need for an upgrade to the intrinsic firmware of the host device to be deployed to multiple devices on a common local area network (LAN) to interoperate and to dynamically modify each other's states in support of multiple use cases.

The rules engine can operate autonomously without the need for an internet connection to apply its last version (prior to loss of internet connectivity) of modified rules as defined.

For example state engine 1 running on a doorbell could contain a rule which states that if the doorbell is rung it should publish this information to the LAN. State engine 2 which may be running on for example a Set Top Box can contain another rule which says that if the doorbell has been rung then it should activate a particular channel on the TV and that it should also publish this fact to the LAN. State engine 3 which may be running on a gateway may have a rule which says that if a particular TV channel is active it should send an alert notification to a cloud platform which in turn can contain a rule that says it should send a push notification to a particular contact.

The rules engine is capable of identifying and applying customisable rules where the triggers are telemetry data points such as temperature, energy consumption etc. This type of rule is referred to as a Telemetry Rule.

The Telemetry Rules can be run on devices regardless of operating system environment including set top boxes, routers, gateways, hubs and similar and also directly on sensors or actuators.

### Technical Implementation Example

An example technical implementation is described. The numbering of the technical building blocks may be understood with reference to FIG. 1, which is provided by way of example.

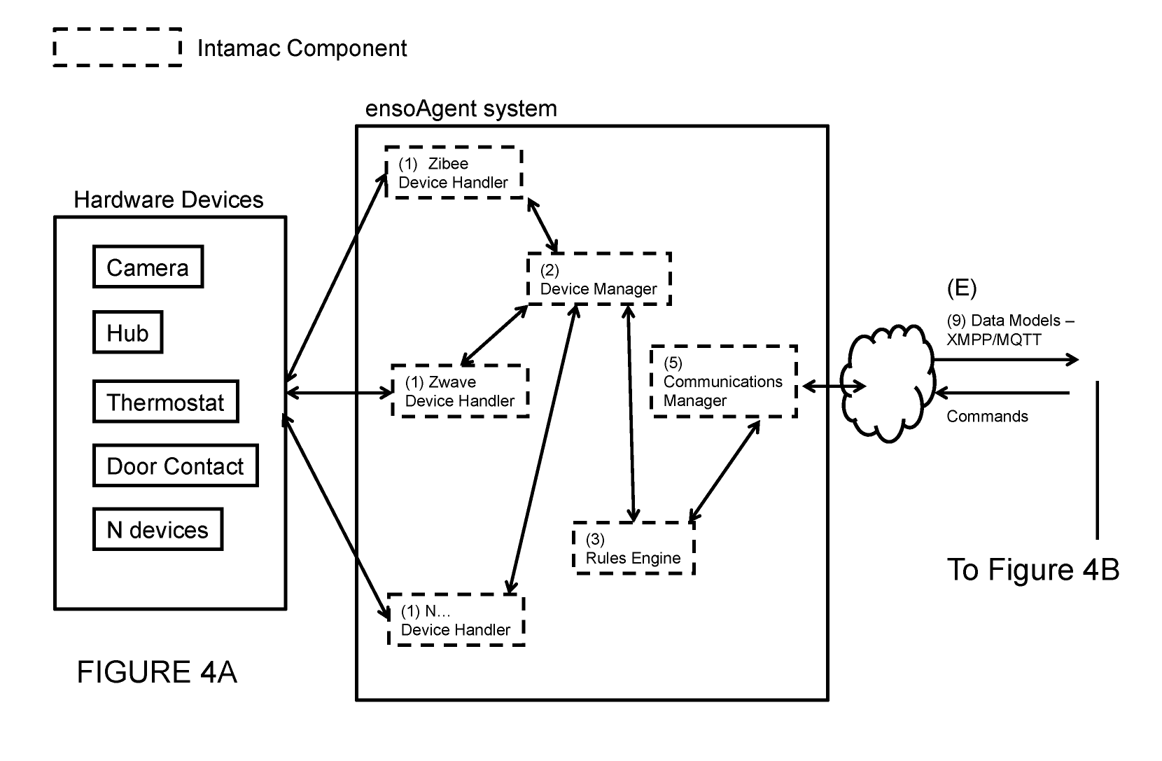

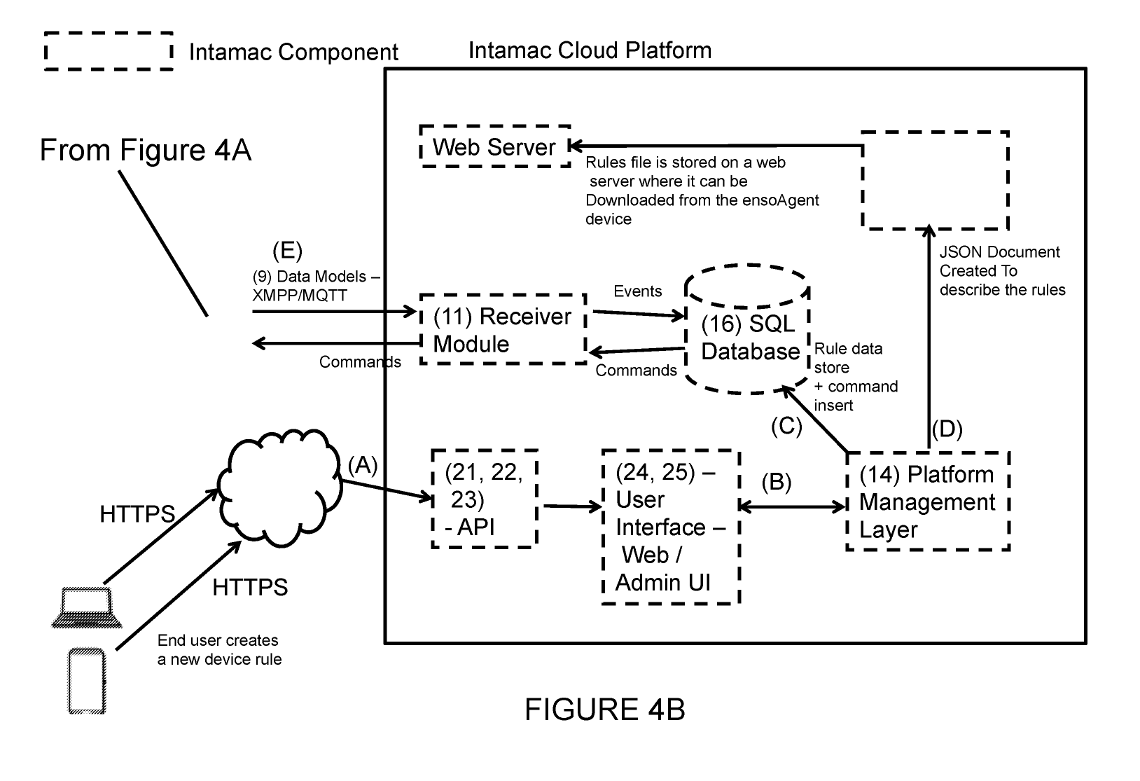

FIGS. 4A & 4B show an example of a system which allows distributed custom generated rules. FIGS. 4A & 4B use the same numbering for technical blocks as in FIG. 1.

Custom cause and effect rules may be generated by end-users using the User Interface (24) that includes a feature that associates events detected by devices connected to the system with outcome actions. See Flow (A) in FIGS. 4A & 4B, for example.

Customer rules may be passed from the user interface (UI) via the ensoCloud platform API's (21-23) to the Platform Management Layer (14). See Flow (B) in FIGS. 4A & 4B, for example. The Platform Management Layer may store information about the custom rules in tables in the SQL DB Design (16), the Platform Management Layer may create the rule file (see Flow (D) in FIGS. 4A & 4B, for example) and the Platform Management Layer may generate the command to tell the ensoAgent system to download the rules file.

The transmission of the rules files from the ensoCloud platform to the ensoAgent system may be handled by the Receiver Module (11) and Communications Manager (5); see Flow (E) in FIGS. 4A & 4B, for example.

Upon completion of this rules distribution process, the custom rule may be applied to events by both the Rules Engine (3) and Platform Management Layer (14), depending on the nature of the cause and effect of the custom rule.

A Rules file can be passed to the Rules Engine (3) without the need to update the intrinsic firmware that is operating on the ensoAgent system. Furthermore, the Rules

Engine (3) or ‘state engine’ can operate independently of the Platform Management Layer (14) and will continue to apply cause and effect rules to locally detected events, even if communications between the Communications Manager (5) and Receiver Module (11) have failed.

The Platform Management Layer (14) is able to receive and distribute rules for multiple Rules Engines (3) or ‘state engines’. Via User Interfaces (24) end-users can configure cause and effect rules that incorporate the input and output of multiple ‘state engines’. The Telemetry Engine (4) may inter-operate with the Rules Engine (3) and enables cause and effect rules to be applied to measureable parameters from devices which are connected to the ensoAgent system via the Device Handler (1) and Device Manager (2).

As a method of defining the rules to be executed within the platform or the ensoAgent system, the system which distributes custom generated rules can describe the cause to be a function of detected ‘presence’ or lack of presence of an individual within the home or within a defined part of the home (or Zone).

In such a presence rule, the individual may be identified by the system by means of sensor input and knowledge of the home configuration (for example possession of a key fob designed to arm and disarm the system and assigned to a specific user of the system). In other cases, the system may be able only to identify the presence of an undetermined individual.

The function of determining presence is by means of aggregating raw sensor data and knowledge of the system configuration and from these, deducing a presence within a property or part of the property. Such a function may be described as a ‘presence engine’. For example, the knowledge that a system is armed and no intruder alarms are generated can be interpreted as there being a lack of presence of any individual within the property. In another example, a named user disarming the system with his assigned keyfob and subsequently triggering a motion sensor within the property can be used to indicate that a specific individual is within the property.

As a further input to a distributed rules system and the presence engine, location information from a mobile device (smartphone/tablet or similar) location services may be used as a data input. Such a mobile device may also be associated with a specific user of the system or may be regarded as having shared ownership. In the former case, it is possible to deduce presence information relating to a specific individual.

This type of input may be used for example by the location of a mobile phone indicating to a heating control system that the phone (and therefore its owner) is within or approaching a property so that the heating system can be automatically activated or a schedule applied based on a presence, or not activated based on absence of a presence.

These presence ‘events’ may be used by the distributed rules system in the same manner as any event.

### Using Security Sensors to Measure Temperature to Aid/Support Energy Conservation

This system, and a related method, enables the use of telemetry and/or event data received from RF connected security devices connected to internet cloud services via a gateway/hub, to support energy conservation.

Telemetry/event data is reported by e.g. door contacts, passive infra red sensors (PIRs), or smoke detectors to identify open doors/windows and ambient temperature in any room in which the sensors are placed.

Actions could be to alert the user via push notification or via direct command from the cloud platform to control the heating in the room via thermostatic radiator valves (TRV) or a programmable room thermostat (PRT). Any controllable device such as a door/window closer, garage door closer can also be controlled as required.

### Technical Implementation Example

An example technical implementation is described. The numbering of the technical building blocks may be understood with reference to FIG. 1, which is provided by way of example.

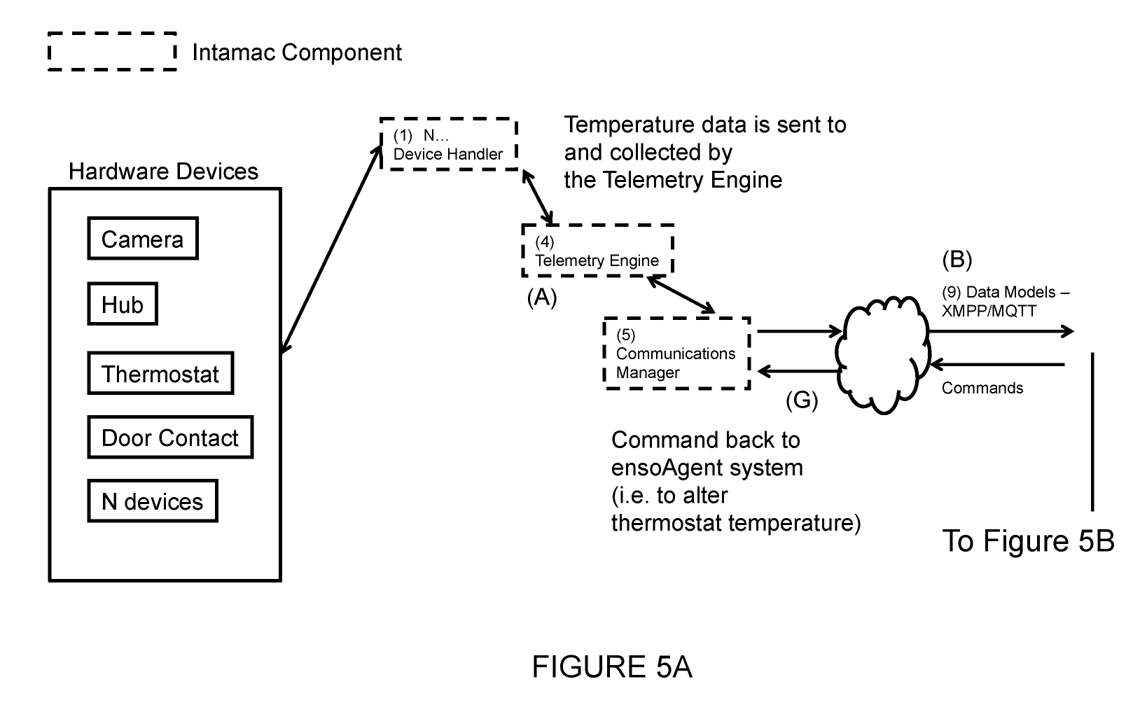

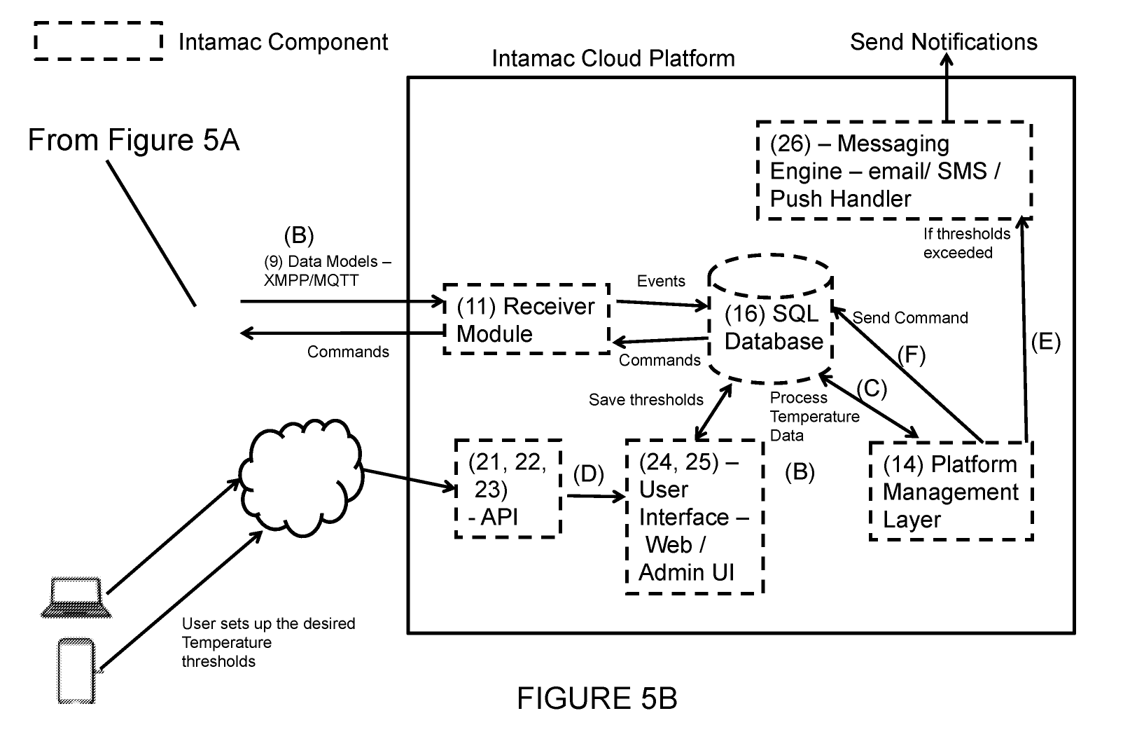

FIGS. 5A & 5B show an example of a system which enables the use of telemetry and/or event data received from RF connected security devices connected to internet cloud services via a gateway/hub to support energy conservation. FIGS. 5A & 5B use the same numbering for technical blocks as in FIG. 1.

The telemetry Engine (4) may report usage data through the Communications Manager (5) at pre-defined regular intervals. See Flow (A) in FIGS. 5A & 5B, for example.

The Communication Manager (5) may pass through this data to the Receiver Module (11), e.g. in the described Data models (9) format, for the connected device. See Flow (B) in FIGS. 5A & 5B, for example.

The Platform Management Layer (14) may processes this data by matching up the device data to customer account data and insert the data in the data store (e.g. SQL DB Design (16)). See Flow (C) in FIGS. 5A & 5B, for example.

The Platform Management Layer (14) may analyse this data for temperature thresholds that can be defined by the end user. The end user can preset these sensor thresholds from the User Interface (24). When a user sets the values, the API (21-23) is used in order to write these thresholds for the particular user account to the data store (SQL DB Design (16)). See Flow (D) in FIGS. 5A & 5B, for example.

If the data being sent to the ensoCloud platform exceeds these thresholds (ie, less than a specified minimum value or greater than a specified maximum value) then the end user may be notified via the Messaging Engine (26) in several available formats including Email, SMS and push notifications. See Flow (E) in FIGS. 5A & 5B, for example.

Alternative actions can also be applied such as altering thermostat desired temperature based on thresholds being exceeded. The Platform Management Layer (14) would determine the desired action and insert the relevant thermostat commands into the data store (SQL DB Design (16)). See Flow (F) in FIGS. 5A & 5B, for example. The Receiver Module (11) would then forward this command on to the ensoAgent for command processing (altering thermostat temperature). See Flow (G) in FIGS. 5A & 5B, for example.

### Using Cloud Connected Safety Sensors to Monitor and Alert on Environmental Conditions within a Home/Premise for Assisted Living Applications, such as Care of the Elderly at Home, and Onward Integration with Third Party Professional Services (e.g. Fire and Rescue)

This system, and a related method, enables the monitoring of environmental conditions within the home of an old or otherwise vulnerable person by the connection of sensors (cold/CO/smoke etc.) to a cloud platform either directly or via an aggregation hub. This system, and a related method, may enable child and/or baby monitoring and/or monitoring school children coming home.

The system, and a related method, also enables potential safety, health and medical issues to be identified by the collection of sensor data (for example use of a motion detector to sense presence or absence within a particular room such as a kitchen) and analytics/rules to determine the possibility that an elderly/vulnerable person may not have eaten if there has been no movement within the kitchen either within a specified time period or for a specific elapsed period of time.

The system, and a related method, allows alert notifications warning of possible safety problems to carers including relatives and professional monitoring service providers by the application of analytics and rules either locally within the device, an aggregation hub or in the cloud to identify possible dangers or risks and for an alert to be sent via a messaging service (SMS, push, email) or the publishing of such alerts via platform APIs to 3^{rd} parties.

The system, and a related method, also includes the onward notification of others of the possible risk sent via a messaging service (SMS, push, email) or the publishing of such alerts via platform APIs to 3rd parties.

### Technical Implementation Example

An example technical implementation is described. The numbering of the technical building blocks may be understood with reference to FIG. 1, which is provided by way of example.

Sensors normally associated with security sensors including passive infrared, door contacts, panic alarms, may report data to ensoAgent system embedded software. This includes movement events, open/close events, panic alarms.

This event data may be transmitted even when the alarm panel/gateway is not in alarm mode. The event data generated may be used to define a history of movement in the property.

The device handler (1) receives the security event data to the ensoAgent rules engine (3) which can determine if a local assisted living rule needs to be activated before passing to the Communications Manager for transfer to the cloud platform.

The Device Manager (2) may report event data through the Communications Manager (5) in real time as the event is generated.

The Communication Manager (5) may pass through this event data to the Receiver Module (11) in the described Data models (9) format for the connected device.

The Platform Management Layer (14) processes this data by matching up the device data to a customer account and inserts the data in the data store (SQL DB Design (16)).

The Platform Management Layer (14) may analyse this data for movement, open/close, panic events.

The end user can define rules within the Platform Manager Layer (14) that are relevant to assisted living scenarios. This includes movement, opening/closing off windows doors, absence of movement, absence of a sensor opening/closing. These rules can also have time parameters associated with the trigger. For example if there is no movement between 8 am and 10 am then trigger the rule.

The rules may be stored in a proprietary DB Schema (16) designed to store rules definitions.

If a rule for the assisted living scenarios is triggered then the end user is notified via the Messaging Engine (26) e.g. in several available formats including Email, SMS and push notifications.

The notification events can also be transferred via the OSS/BSS integration (20) to professional monitoring services to be handled manually by operations centre personnel.

The event data can also be viewed via multiple User Interfaces (UIs) (24) via the use of API's (23) that allow secure access to the cloud platform database e.g. via RESTful services.

### A Web Based System Allowing Professional Security Monitoring Services to be Booked by Consumers on a Pay as You Go (PAYG) Basis

This system, and a related method, enables users/operators to use mobile apps or websites to book professional security monitoring cover of their domestic/commercial security systems for a fixed time period through the use of a calendar (e.g. a home user booking and paying for professional security monitoring of an individual property only for the period while on holiday/vacation).

The system, and a related method, may include the back end integration of a cloud platform to which security devices are connected with the systems of a professional security monitoring provider so that the activation of the temporary professionally monitored service by the user/operator can be automatically enabled with the monitoring providers systems.

The end to end integration allows for home owners' details to be registered with the professional monitoring service at the time when the home alarm/monitoring system is installed and thereby allows for the seamless commissioning and decommissioning of the professional cover by the end user as and when required.

This system, and a related method, also enables ‘push notifications’ to be used as a messaging method in cloud platform connected security and monitoring systems and for customisable rules based messaging to be used to automate the distribution of notification messages.

Devices can be configured via rules set on the cloud platform to send alerts and notifications via push notification technology.

### Technical Implementation Example

An example technical implementation is described. The numbering of the technical building blocks may be understood with reference to FIG. 1, which is provided by way of example.

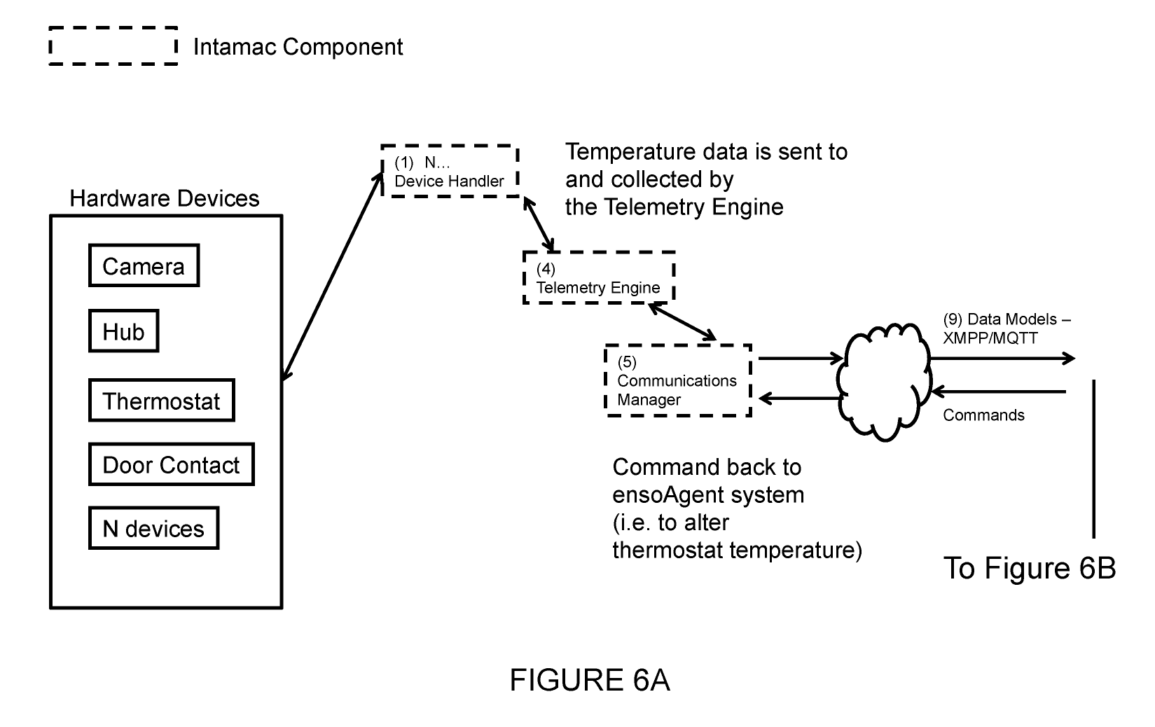

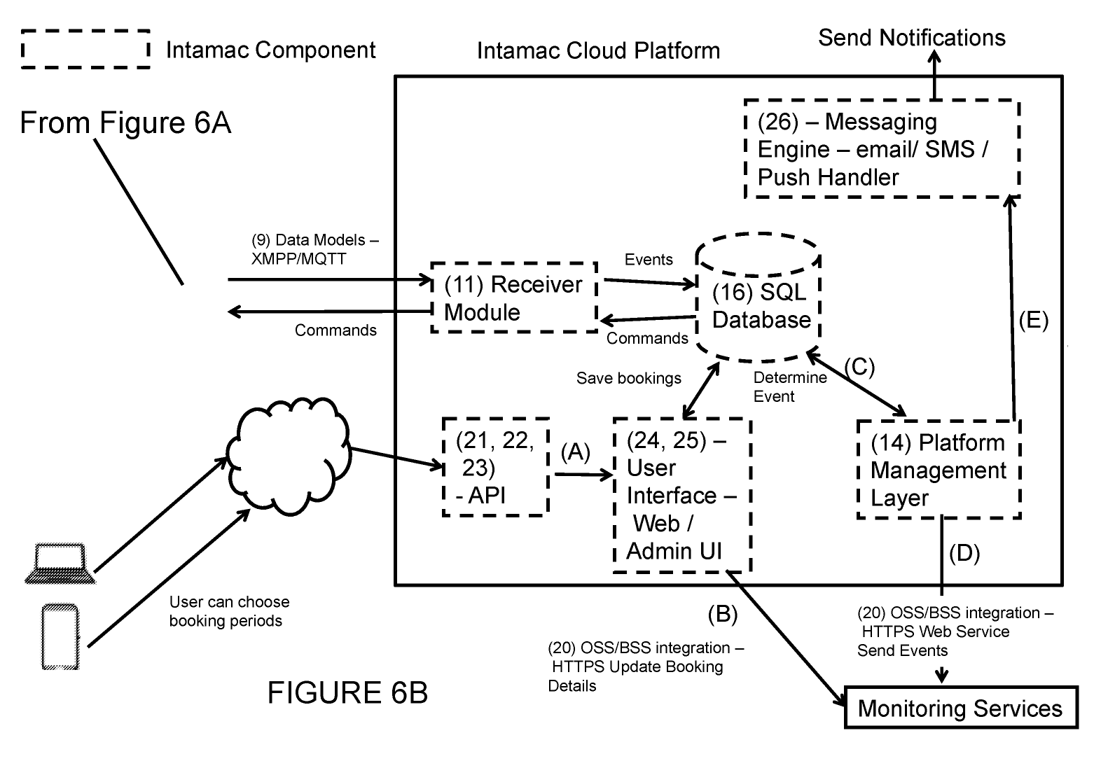

FIGS. 6A & 6B show an example of a web based system allowing professional security monitoring services to be booked by consumers on a pay as you go (PAYG) basis. FIGS. 6A & 6B use the same numbering for technical blocks as in FIG. 1.

A User Interface (24) may support a calendar style interface wherein the end user has the ability to make bookings for specific whole day date ranges. The API (21-23) is used to insert the relevant booking details into the data store (e.g. SQL DB Design (16)). See Flow (A) in FIGS. 6A & 6B, for example.

OSS/BSS Integration (20) may then be used in order to integrate with the professional security monitoring provider. This interface can be interchangeable so that integration to multiple security monitoring providers is possible. Customer data and booking data is exchanged with the provider. See Flow (B) in FIGS. 6A & 6B, for example.

When an event is received from the device through the Receiver Module (11) the Platform Management Layer (16) may determine if the event is a supported event that needs to be forwarded to the security monitoring provider. This determination may be made based on if the current date is within the booking date range that has been set by the end user. See Flow (C) in FIGS. 6A & 6B, for example. If the event is required to be sent on then the OSS/BSS Integration (20) may be used in order to communicate the event with the provider. This communication may be via HTTPS or TCP depending on the providers interface. See Flow (D) in FIGS. 6A & 6B, for example.

In parallel to the events being sent to the security monitoring service provider the Messaging Engine (26) is used to deliver notifications to the end user in various formats such as Email, SMS or push notifications. See Flow (E) in FIGS. 6A & 6B, for example.

### Using QR codes in a Method to Identify and Pair/Connect Sensor Devices to a Hub/Gateway Device for Cloud Based Monitoring and Alerting Systems

This system, and a related method, allows the use of QR (Quick Response) scanning technology running on a smartphone/tablet or similar device as a means to identify a sensor or actuator device (for example PIR, IP Camera, Door Lock, Door Contact etc.) to a hub/gateway or similar aggregation device.

A QR scan may be used to scan and identify the settings and parameters of the sensor/actuator and to pass this data via a cloud platform that can onward push the information to the aggregation device allowing rapid pairing without the requirement for the user to ‘key in’ any unique identifier information such as a media access control address (MAC address), serial number or other address.

The same system can be used to capture the settings and parameter data of a device such as a hub, sensor, actuator etc. to register it to a cloud platform in the same way.

This system, and a related method, also allows the use of NFC (Near Field Communications) technology running on a smartphone/tablet or similar device as a way to identify a sensor or actuator device (for example PIR, IP Camera, Door Lock, Door Contact etc.) with NFC to a hub/gateway or similar aggregation device. This is similar to the QR concept but using NFC technology to share the data rather than a QR code.

NFC is used to scan and identify the settings and parameters of the sensor/actuator and to pass this data via a cloud platform that can onward push the information to the aggregation device allowing rapid pairing without the requirement for the user to key in any unique identifier information such as a MAC address, serial number or other identifier.

The same method can be used to capture the setting and parameter data of a device such as a hub, sensor, actuator etc. to a cloud platform.

### Technical Implementation Example

An example technical implementation is described. The numbering of the technical building blocks may be understood with reference to FIG. 1, which is provided by way of example.

A UI (24) for smartphone or tablet mobile device may be created that incorporates a QR code or NFC (Near Field Communications) scanning application. Sensor devices that are connected to the system are manufactured with a QR readable label, or include NFC technology, that uniquely identifies the sensor device's networking parameters, e.g. the device's MAC address or a unique serial number.

An end-user may connect to the ensoCloud service system via their smartphone or tablet via its UI (24). Upon scanning the QR or NFC code of the device that is to be paired with the hub/gateway of the end-user's account, the UI (24) may securely send the network parameters of the device via the APIs (21-23) to the Receiver Module (11). The Receiver Module may pass the device information to the Platform Management Layer (14) which may update the end-user's database record of the SQL DB Design (21-23) to include the newly added device.

### Interchangeable and Dynamic Local or Cloud Control of the Same Device Depending on User'S Location

This system, and a related method, provides the ability to switch a control method of an internet connected device (e.g. a light bulb or smart switch; e.g. any device with an ‘ON’ ‘OFF’ function) so that the device can be controlled either remotely via a cloud platform from smartphone/tablet/web apps when the user is not on the same local area network as the connected device. Or when the smartphone/tablet/web app device is local (e.g. on the same Local area network) to the internet connected device, control is switched to being local and directly between the app and the device across the local LAN, thereby improving performance and/or reducing latency.

### Technical Implementation Example

An example technical implementation is described. The numbering of the technical building blocks may be understood with reference to FIG. 1, which is provided by way of example.

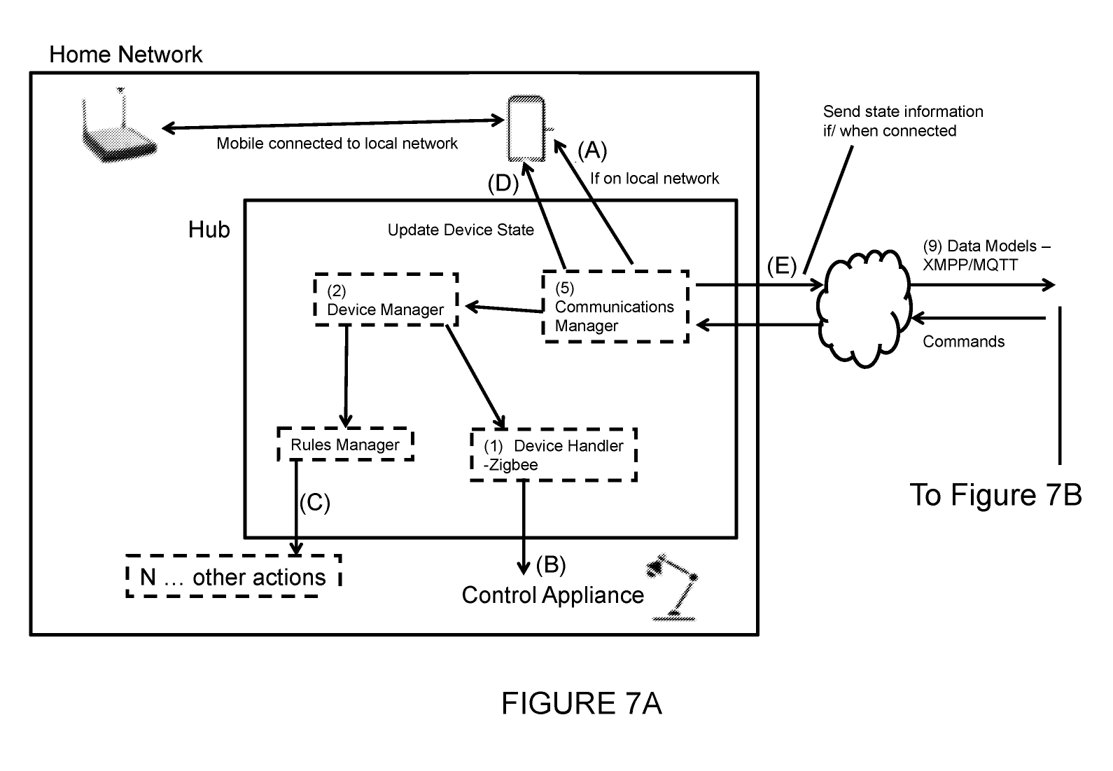

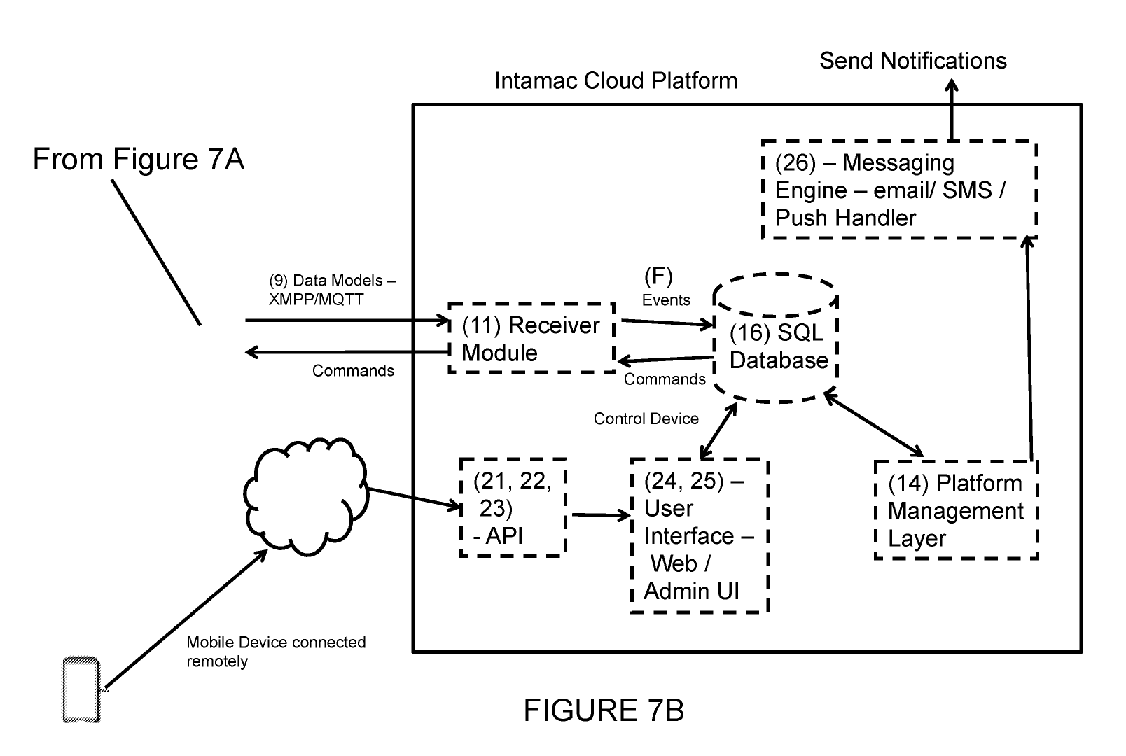

FIGS. 7A & 7B show an example of a system in which interchangeable and dynamic Local or Cloud control of the same device depending on users location is provided. FIGS. 7A & 7B use the same numbering for technical blocks as in FIG. 1.

An end user may enter the Service set identification (SSID) of the Wi-Fi local area network (LAN) that the devices are connected to. This will be the Wi-Fi network onto which the device or gateway is connected.

The end user mobile application connects to this Wi-Fi network. This is achieved by the fact that the end user has connected to the Wi-Fi network previously. When in range and connected to the Wi-Fi network the ensoAgent system embedded software, including the Device Handler (1), Device Manager (2) and Communications Manager (3), may detect the presence of the mobile device.

The mobile device may be authenticated based on the fact that it has previously been connected to the Wi-Fi network using the SSID and password. The username and password for access to the account may also be stored on the local device/gateway to gain access.

Once connected to the local network, device commands are sent directly from the mobile device to the Communications Manager (5) which may receive and process the commands. See Flow (A) in FIGS. 7A & 7B, for example.

The command may be passed from the communications manager (5) to the Device Manager (2) which in turn converts the command to be sent by the relevant device handler to be sent to the device/sensor. See Flow (B) in FIGS. 7A & 7B, for example.

The feedback/state of the device may be returned to the Device Handler (1) and Device Manager (2). The Device Manager (2) may pass this information/data to the rules engine (3) which may determine if any other action needs to be triggered based on a change in the original sensor, e.g. if the plug is switched on then turn light 1 on. See Flow (C) in FIGS. 7A & 7B, for example. The communications manager (5) will then send the data/event to the local applications to update the state. See Flow (D) in FIGS. 7A & 7B, for example.

The communication Manager buffers state and passes this information to the receiver application (1) when it has an outbound internet connection. This ensures that the cloud platform is synchronized in the absence of an internet connection from the property. See Flow (E) in FIGS. 7A & 7B, for example.

The device status is stored in the cloud platform database (16) so it can be viewed by any other application/UI (24) accessing the account via the API's (21-23). See Flow (F) in FIGS. 7A & 7B, for example.

An extension of the embedded agent system is to interface to camera devices and handle video.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A system comprising an agent system and a cloud platform,
the agent system including a device handler and a communications manager,
the cloud platform including components including: a receiver module; a platform management layer including a rules engine; a database; application programming interfaces (APIs), and a user interface,
wherein the agent system is configured to communicate with the receiver module via the communications manager, using a data model, the device handler configured to communicate with a plurality of devices each including respective firmware, the device handler configured to communicate with the communications manager,
wherein the receiver module is configured to receive event data generated by the respective firmware on the plurality of devices, and to pass event data to the database to be stored, wherein stored event data in the database is accessible to the platform management layer, the platform management layer configured to process the event data according to the rules engine to generate output actions, commands or messaging,
wherein the APIs are connectable via the user interface to at least one other cloud platform component, which is operable via the APIs to push a command or new firmware to a connected device in the plurality of devices.

2. The system of claim 1, wherein the device handler is provided as an embedded software module.

3. The system of claim 1, wherein the device handler is configured to communicate with the plurality of devices using radio frequency (RF) communications.

4. The system of claim 1, wherein the device handler is configured to abstract command messages from the cloud platform so as to be radio technology agnostic.

5-9. (canceled)

10. The system of claim 1, wherein passed data and commands between the agent system and the cloud platform are secured using encryption.

11. The system of claim 1, wherein the communications manager handles a device being connected or disconnected in the background.

12-14. (canceled)

15. The system of claim 1, wherein the database is a time series database design which stores the event, telemetry and diagnostic information that can be reported by the devices/sensors connected to the cloud platform.

16-21. (canceled)

22. The system of claim 1, wherein the user interface supports connected home services.

23. The system of claim 22, wherein the home services include one or more of security, video, automation, heating, lighting, rules, and social care.

24-25. (canceled)

26. The system of claim 1, wherein the new firmware includes non-intrinsic firmware, wherein the non-intrinsic firmware is embedded software or scripts which may be run alongside the intrinsic firmware.

27-28. (canceled)

29. The system of claim 1, wherein the firmware includes camera firmware.

30-32. (canceled)

33. The system of claim 1, wherein the agent system includes a rules engine, wherein the rules engine controls system logic for connected home services.

34. (canceled)

35. The system of claim 33, wherein the rules engine allows the agent system to make decisions based on data that is received from sensors registered to the agent system without the need to communicate with the cloud platform.

36-37. (canceled)

38. The system of claim 1, wherein the agent system includes a Telemetry Rules Engine, wherein the Telemetry Rules Engine monitors the flow of regularly reported telemetry data values such as energy, power, temperature, voltage, flow-rate, speed, rpm and acceleration, wherein the Telemetry Rules Engine includes bounds checks which generate events if the bounds are exceeded.

39-40. (canceled)

41. The system of claim 1, wherein the agent system includes a camera, wherein the cloud platform triggers an alarm on an alarm generating device when motion is detected on the camera.

42-44. (canceled)

45. The system of claim 1, wherein the agent system includes a Video Communications Manager.

46-47. (canceled)

48. The system of claim 45, wherein the Video Communications Manager uses a combination of STUN (Session Traversal Utilities for NAT (Network address translation)) and XMPP to provide a communications mechanism to negate NAT traversal and remove the need for an end user to enable port forwarding for the device.

49. The system of claim 45, wherein the Video Communications Manager uses a combination of STUN (Session Traversal Utilities for NAT (Network address translation)) and MQTT to provide a communications mechanism to negate NAT traversal and remove the need for an end user to enable port forwarding for the device.

50. The system of claim 1, wherein the agent system includes audio analysis functions, wherein the agent system audio analysis functions include a rule that if a specific sound is detected then the agent system generates an event that is sent to the cloud platform to be processed.

51-52. (canceled)

53. The system of claim 1, wherein the agent system includes a Video Stream Transmission function, wherein the Video Stream Transmission function includes receiving a video stream from a camera, and sending the stream to the cloud platform.

54-61. (canceled)

62. The system of claim 1, wherein the cloud platform includes a video receiver, wherein the video receiver includes the functions of receiving a video stream and then performing decryption and then passing the decrypted video stream to a video proxy server to be transcoded and streamed to a requesting device.

63-66. (canceled)

67. The system of claim 1, wherein the cloud platform includes a messaging engine.

68. Computer implemented method of operating a system comprising an agent system and a cloud platform,
the agent system including a device handler and a communications manager,
the cloud platform including components including: a receiver module; a platform management layer including a rules engine; a database; application programming interfaces (APIs), and a user interface, the method including the steps of:
(i) the agent system communicating with the receiver module via the communications manager, using a data model,
(ii) the device handler communicating with a plurality of devices each including respective firmware,
(iii) the device handler communicating with the communications manager,
(iv) the receiver module receiving event data generated by the respective firmware on the plurality of devices, and passing event data to the database to be stored,
(v) the platform management layer accessing stored event data in the database,
(vi) the platform management layer processing the stored event data according to the rules engine to generate output actions, commands or messaging,
(vii) the APIs connecting via the user interface to at least one other cloud platform component, and
(viii) the at least one other cloud platform component being operated by the APIs to push a command or new firmware to a connected device in the plurality of devices.

69-249. (canceled)
